(19) United States
(12) Patent Application Publication
(10) Pub. No.: US 2009/0085256 A1
(43) Pub. Date: Apr. 2, 2009

(54) IMAGE FORMING METHOD AND APPARATUS

(76) Inventor: Hiroshi MATAKI, Ashigarakami-gun (JP)

Correspondence Address: BIRCH STEWART KOLASCH & BIRCH, PO BOX 747, FALLS CHURCH, VA, 22040-0747, US

(21) Appl. No.: 12/239,528

(22) Filed: Sep. 26, 2008

(30) Foreign Application Priority Data
Sep. 28, 2007 (JP) 2007-256737

(51) Int. Cl. B29C 35/08

(52) U.S. Cl. 264/401; 425/174.4

(57) ABSTRACT

The image forming method forms a three-dimensional shape on a medium by stacking up a plurality of droplets of liquid on a same droplet deposition point on the medium. The method includes the steps of: depositing a first droplet of the liquid onto the medium; then solidifying the first droplet while carrying out a process whereby an upper surface of the first droplet assumes a depressed shape; and then depositing a second droplet of the liquid onto the first droplet.

### BACKGROUND OF THE INVENTION

1. Field of the Invention

The present invention relates to an image forming method and apparatus, and more particularly, to image forming technology for forming a three-dimensional shape by stacking together layers of deposited of liquid onto a medium having non-permeable properties.

2. Description of the Related Art

An inkjet recording apparatus which forms a high-definition image by depositing minute droplets of ink onto a recording paper is suitable for use as an apparatus for outputting images or documents. In recent years, inkjet recording apparatuses have come to be used widely as apparatuses for outputting image or three-dimensional shapes, or the like, onto various media other than paper media, as well as apparatuses for outputting images and documents onto paper media. For example, a three-dimensional pattern can be formed on a substrate by depositing a resin liquid, or the like, onto a medium (substrate) having non-permeable properties by using an inkjet recording apparatus, then a prescribed thickness can be ensured by stacking a plurality of droplets of the resin liquid on the substrate in a superimposed fashion.

Japanese Patent Application Publication No. 05-330151 discloses a braille printer that records three-dimensional shapes such as dots representing Braille, usual (non-Braille) characters, maps, or the like; by performing superimposed recording using a hot melt ink that solidifies at room temperature.

However, when the size and angle of contact of the droplets are predetermined when the droplets are stacked on each other, then the shape of the droplets is predetermined. Consequently, the heights (the thicknesses) of the dots are dependent on the breadths of the dots, and it is not possible to change the heights while keeping the breadths uniform. In other words, even if the droplets are stacked on top of each other to a great height in the height direction, the liquid spreads in the breadthways direction and therefore it is difficult to form a three-dimensional shape that has a high aspect ratio.

In Japanese Patent Application Publication No. 05-330151, although it is sought to stack ink up in the height direction by means of superimposed deposition, there is no disclosure how to accurately stack the ink in the height direction. More specifically, in Japanese Patent Application Publication No. 05-330151, dots representing Braille and the like are formed by using ink droplets having a smaller size than the desired dot size, in order to take account of the fact that the ink spreads in the breadthways direction when it is stacked.

### SUMMARY OF THE INVENTION

The present invention has been contrived in view of these circumstances, an object thereof being to provide an image forming method and an image forming apparatus which forms a three-dimensional shape on the medium while controlling the width and height independently by stacking droplets in a superimposed fashion on the medium.

In order to attain the aforementioned object, the present invention is directed to an image forming method for forming a three-dimensional shape on a medium by stacking up a plurality of droplets of liquid on a same droplet deposition point on the medium, the method comprising the steps of: depositing a first droplet of the liquid onto the medium; then solidifying the first droplet while carrying out a process whereby an upper surface of the first droplet assumes a depressed shape; and then depositing a second droplet of the liquid onto the first droplet.

According to this aspect of the present invention, when forming a three-dimensional shape by stacking up a plurality of droplets ejected onto the same droplet ejection point, the upper surface of the droplet deposited previously on the medium is made to assume a depressed shape and is solidified while the upper surface maintains this depressed shape, whereupon a subsequent droplet is deposited onto the droplet having the upper surface with the depressed shape. Consequently, even if the subsequent droplet is deposited onto the droplet that has been deposited previously on the medium, the droplet maintains the solidified shape and does not spread, and therefore the width and height of the three-dimensional shape can be controlled independently and the three-dimensional shape having a high aspect ratio can be formed.

A shape having a depressed upper surface is, for example, the shape of a droplet in which a recess portion is formed in the vicinity of the central portion and including the central portion of the liquid droplet (in other words, the periphery of the central portion of the droplet).

Preferably, the liquid has a function of being solidified when being irradiated with radiation; and the solidifying step includes the step of irradiating the radiation more intensely onto a prescribed region including a central portion of the first droplet than another region of the first droplet.

According to this aspect of the present invention, in the prescribed region including the central portion of the droplet which receives the radiation intensely, evaporation of the solvent component of the liquid droplet and the droplet solidifies in the depressed state. On the other hand, in the peripheral portion of the droplet which receives the radiation more weakly than the prescribed region including the central portion, then evaporation of the solvent component does not occur and therefore the droplet solidifies while maintaining the shape of the droplet. Consequently, the droplet solidifies with the upper surface assuming the depressed shape.

It is also preferable that the liquid has a function of being solidified when being irradiated with radiation; and the solidifying step includes the steps of: inserting a hollow needle having a diameter smaller than a diameter of the first droplet into the upper surface of the first droplet; then irradiating the radiation from periphery of the first droplet in a state where the hollow needle is being inserted in the upper surface of the first droplet; and then suctioning the liquid inside the hollow needle that is left without being solidified.

According to this aspect of the present invention, since the radiation does not strike the area inside the hollow needle and hence the liquid there remains without being solidified, then it is possible to solidify the liquid droplet while the upper surface maintains a concave shape by removing the liquid component inside the needle after solidifying the droplet from the periphery by irradiating the radiation from the periphery of the droplet.

In order to attain the aforementioned object, the present invention is also directed to an image forming apparatus, comprising: a head provided with a nozzle which performs ejection of a droplet of liquid toward a medium; a solidification device which solidifies the droplet that has been deposited on the medium while carrying out a process whereby an upper surface of the droplet assumes a depressed shape; and a droplet ejection control device which controls the ejection of a subsequent droplet of the liquid onto the droplet that has the upper surface formed in the depressed shape and has been solidified by the solidification device, whereby forming a three-dimensional shape on the medium by stacking up the droplets.

According to this aspect of the present invention, when forming a three-dimensional shape by stacking up a plurality of liquid droplets at the same droplet ejection point, the upper surface of a droplet that has been deposited previously on the medium is solidified in a depressed shape and therefore it is possible to stack the plurality of droplets reliably on each other without the droplets spreading when a subsequent droplet lands on the previously deposited droplet, and therefore independent control of the width and height of the three-dimensional shape is possible.

Preferably, the liquid has a function of being solidified when being irradiated with radiation; and the solidification device includes: a radiation irradiation device which irradiates the radiation onto the droplet; and a radiation irradiation control device which controls the radiation irradiation device in such a manner that the radiation is irradiated intensely onto a prescribed region including a central portion of the droplet than another region of the droplet.

The radiation irradiation control device may control the irradiation light quantity (central intensity) and the irradiation diameter (full width at half maximum) of the radiation irradiation device.

Preferably, the image forming apparatus further comprises: a head movement device which moves the head relative to the medium; and a radiation source movement device which moves the radiation irradiation device relative to the medium, wherein: the radiation irradiation device is arranged to an upstream side of the head in terms of a direction of movement of the movement device, and moves while following the head; and the radiation irradiation control device controls turning on and off of the radiation irradiation device in such a manner that the radiation is irradiated onto the droplet that is being situated directly below the radiation irradiation device.

According to this aspect of the present invention, since the droplet that has been ejected from the head is solidified by means of radiation irradiated from the radiation irradiation device which follows the head, then it is possible to eject droplets and solidify the droplets with good efficiency.

In a mode where a plurality of nozzles are provided in the head, it is desirable to provide one radiation irradiation device (radiation light source) to correspond to each nozzle.

It is also preferable that the image forming apparatus further comprises: a head movement device which moves the head relative to the medium; a radiation source movement device which moves the radiation irradiation device relative to the medium; and a shutter mechanism which is arranged between the radiation irradiation device and the medium, wherein the radiation irradiation control device controls turning on and off of the radiation irradiation device by opening and closing the shutter mechanism in such a manner that the radiation is irradiated onto the droplet that is being situated directly below the radiation irradiation device.

In a mode where a plurality of nozzles are provided in the head, a common ultraviolet irradiation device is provided for the plurality of nozzles and one shutter mechanism is provided for each nozzle, it being possible to irradiate the ultraviolet light selectively in accordance with the ejection of droplets from the respective nozzles by means of opening and closing the shutter mechanisms.

It is also preferable that the liquid has a function of being solidified when being irradiated with radiation; and the solidification device includes: a hollow needle which has a diameter smaller than a diameter of the droplet; a needle movement device which inserts the hollow needle into the upper surface of the droplet; a liquid removal device which removes the liquid inside the hollow needle; a radiation irradiation device which irradiates the radiation onto the droplet; a radiation irradiation control device which controls the radiation irradiation device and the needle movement device so as to perform irradiation of the radiation from periphery of the droplet in a state where the hollow needle is being inserted in the upper surface of the droplet; and a liquid removal control device which controls the liquid removal device so as to remove the liquid inside the hollow needle that is left without being solidified after the irradiation of the radiation.

A desirable mode is one where a suction device which suctions the interior of the hollow needle is provided and the liquid component inside the needle is suctioned and removed after the droplet has solidified.

According to the present invention, when forming a three-dimensional shape by stacking up a plurality of droplets ejected onto the same droplet ejection point, the upper surface of the droplet deposited previously on the medium is made to assume a depressed shape and is solidified while the upper surface maintains this depressed shape, whereupon a subsequent droplet is deposited onto the droplet having the upper surface with the depressed shape. Consequently, even if the subsequent droplet is deposited onto the droplet that has been deposited previously on the medium, the droplet maintains the solidified shape and does not spread, and therefore the width and height of the three-dimensional shape can be controlled independently and the three-dimensional shape having a high aspect ratio can be formed.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIGS. 1A to 1D are conceptual diagrams describing a three-dimensional pattern forming method according to an embodiment of the present invention;

FIGS. 2A to 2C are diagrams describing height control in the three-dimensional pattern forming method shown in FIGS. 1A to 1D;

FIGS. 3A and 3B are conceptual diagrams showing one mode of the three-dimensional pattern forming method shown in FIGS. 1A to 1D;

FIGS. 4A and 4B are conceptual diagrams showing a further mode of the three-dimensional pattern forming method shown in FIGS. 1A to 1D;

FIG. 5 is a plan diagram showing an embodiment of the composition of a head which is used in the three-dimensional pattern forming method shown in FIGS. 3A and 3B;

FIGS. 6A to 6C are conceptual diagrams showing an embodiment of the formation of a three-dimensional pattern using the head shown in FIG. 5;

FIG. 7 is a plan diagram showing a further embodiment of the composition of the head shown in FIG. 5;

FIGS. 8A to 8C are conceptual diagrams showing an embodiment of the formation of a three-dimensional pattern using the head shown in FIG. 5;

FIG. 9 is a table for describing an embodiment of the control of ultraviolet light in the three-dimensional pattern forming method shown in FIGS. 3A and 3B;

FIG. 10 is an approximate compositional diagram showing an embodiment of the composition of an image forming apparatus which employs the head show in FIG. 5;

FIG. 11 is a plan diagram of the image forming apparatus shown in FIG. 10;

FIG. 12 is an embodiment of the structure of the head shown in FIG. 5;

FIGS. 13A and 13B are a further embodiment of the structure of the head shown in FIG. 5; and

FIG. 14 is a block diagram showing an embodiment of the system configuration of the control system of the image forming apparatus shown in FIG. 10.

### DETAILED DESCRIPTION OF THE PREFERRED EMBODIMENTS

### Description of Three-Dimensional Pattern Forming Method

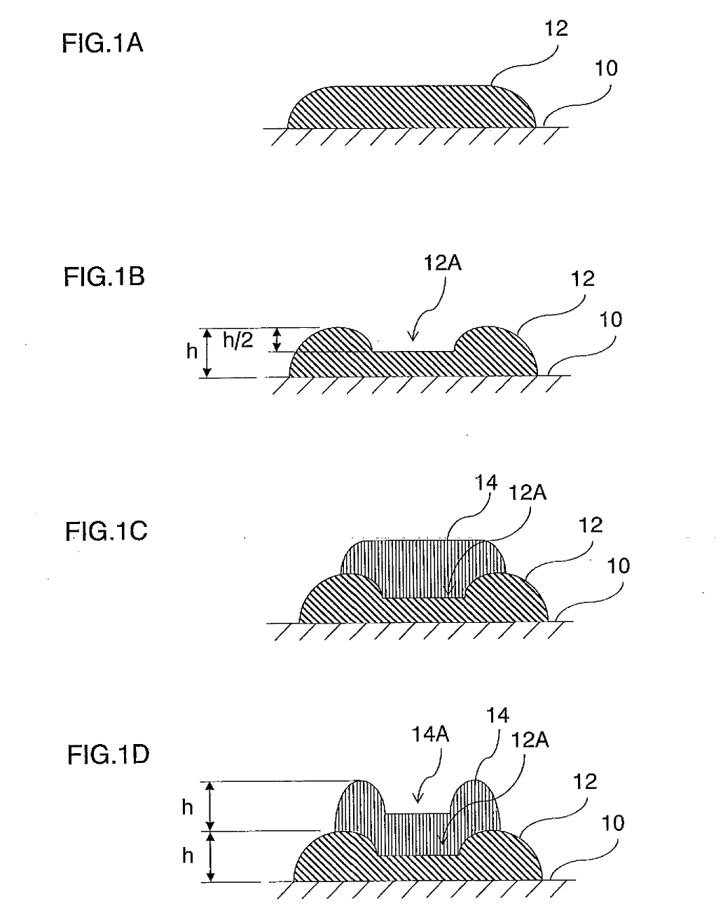

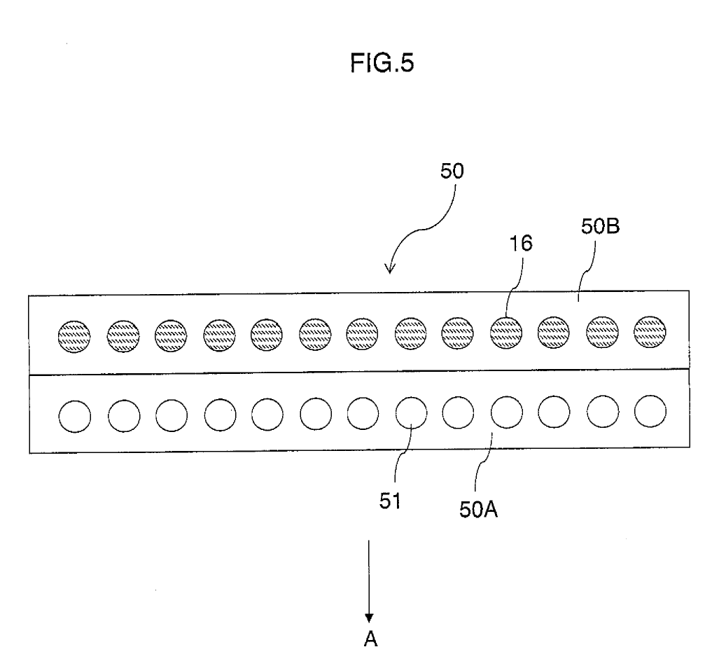

FIGS. 1A to 1D are conceptual diagrams showing schematic views of the steps of a method of forming a three-dimensional pattern or shape (image forming method) according to an embodiment of the present invention. The three-dimensional pattern forming method described in the present embodiment forms a three-dimensional pattern by stacking up a plurality of droplets at a single droplet deposition point on a medium 10, by ejecting the droplets from a nozzle 51 (shown in FIG. 5) arranged in a head 50 (shown in FIG. 5) onto the medium 10 having non-permeable properties (e.g. a paper medium, resin medium, metal medium, or the like).

FIG. 1A is a cross-sectional diagram of a state where a first droplet 12 has landed on the medium 10. After the first droplet 12 lands on the medium 10 as shown in FIG. 1A, the droplet 12 undergoes a solidification process while undergoing a deformation process whereby the upper surface of the droplet 12 assumes a depressed shape. As shown in FIG. 1B, the droplet 12 having landed on the medium 10 is formed with a recess portion 12A at a prescribed region that includes the central portion of the upper surface, and furthermore the droplet 12 solidifies while maintaining the shape having the recess portion 12A. FIG. 1B shows the recess portion 12A having a depth that is one half of the height h of the droplet 12. A desirable mode is one where the depth of the recess portion 12A is not smaller than ⅓ and not larger than ⅔ of the height h of the droplet 12.

The solidification process applied in the present embodiment is a non-reversible process, and even if a second droplet 14 (see FIG. 1C) is deposited in a superimposed fashion onto the droplet 12 after the solidification process, the solidified droplet 12 does not revert to its original shape or its original liquid state. Moreover, the recess portion 12A may also be formed on the upper surface of the droplet 12 as a result of the process of solidifying the droplet 12.

When the droplet 12 having the depressed upper surface and formed with the recess portion 12A has solidified while maintaining this shape as shown in FIG. 1B, then the second droplet 14 is stacked on top of the first droplet 12 as shown in FIG. 1C. The second droplet 14 has the same volume as the first droplet 12 and is ejected toward the same depositing position as the droplet 12.

Due to the formation of the recess portion 12A caused by the depressed shape of the upper surface of the droplet 12, when the second droplet 14 (the second and subsequent droplets) is stacked thereon, even if there is divergence in the depositing position of the second droplet 14, the second droplet 14 will flow into the recess and therefore high stability is achieved.

When the second droplet 14 lands on the first droplet 12, the second droplet 14 undergoes a solidification process while also undergoing a deformation process (a process of forming a recess portion 14A) whereby the upper surface of the droplet 14 assumes a depressed shape as shown in FIG. 1D. When the second droplet 14 has undergone the solidification process, the second droplet 14, which has the same height h as the first droplet 12 will be stacked upon the first droplet 12 having the height h, in a state where the first droplet 12 maintains the diameter it formed upon deposition and does not spread in the surface direction of the medium 10. Accordingly, a three-dimensional shape (dot) having a height of 2×h is formed.

In this way, by repeating the process of deposition of the droplet and solidification of the droplet n times, then a three-dimensional pattern having a height of n×h composed of n droplets stacked upon each other will be formed. In FIGS. 1A to 1D, the description centered on one droplet (dot), but in actual practice dot rows (a dot pattern) having a prescribed shape are formed in the surface direction of the medium 10 by respective first dots, and a three-dimensional pattern is formed by stacking n dots in the height direction on these dot rows.

The recess portion 12A shown in FIGS. 1B to 1D is formed in a region including the approximate central portion of the upper surface of the droplet 12, and the planar shape (not shown in the drawings) of the recess portion 12A is substantially a circular shape.

In the present embodiment, the mode is shown in which the droplets of the same size are stacked upon each other; however, when stacking the droplets of the same size, the resolution in the height direction is predetermined by the size of the droplets. It is possible to achieve a finer resolution in the height direction by making the droplets smaller in size and further adjusting the size of each of the droplets.

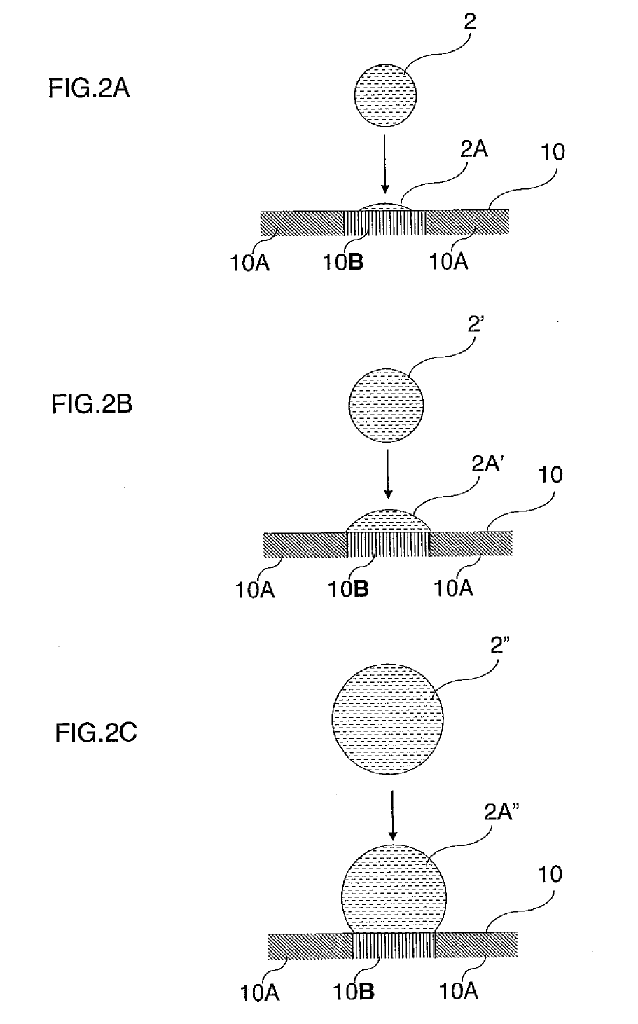

It is also desirable that the height is controlled by controlling the droplet volume by means of a surface treatment of the medium 10. More specifically, as shown in FIGS. 2A to 2C, if patterns of a liquid-repelling portion 10A and a wettable portion 10B are formed on the surface of the medium 10, where the width of the wettable portion 10B is set to a desired width and the droplet 2 is deposited onto the wettable portion 10B, then the droplet (liquid) 2 only wets the wettable portion 10B and therefore the height of the droplet can be controlled on the basis of the droplet volume. The droplet 2′ in FIG. 2B has a larger droplet volume than the droplet 2 in FIG. 2A, and therefore the height of the droplet 2A′ after deposition shown in FIG. 2B is greater than the height of the droplet 2A after deposition shown in FIG. 2A.

However, in this case, there are restrictions on the stacking height due to the angle of contact between the droplet and the base material of the portion where the liquid-repelling pattern has been formed. More specifically, as shown in FIG. 2C, if the diameter of the droplet 2A″ upon landing is greater than the width of the wettable portion 10B, it is not possible for the droplet 2A″ to wet and spread on the liquid-repelling portion 10A of the medium 10, and therefore the droplet 2A″ is constricted to the wettable portion 10B and the height control is restricted.

### Specific Embodiments of Solidification Process

Next, specific embodiments of the above-described solidification process are explained. In the present embodiments, a mode is described in which a material that is solidified by the irradiation of ultraviolet light (ultraviolet-solidifiable liquid) is used as the liquid to form the droplets.

### Specific Embodiment 1

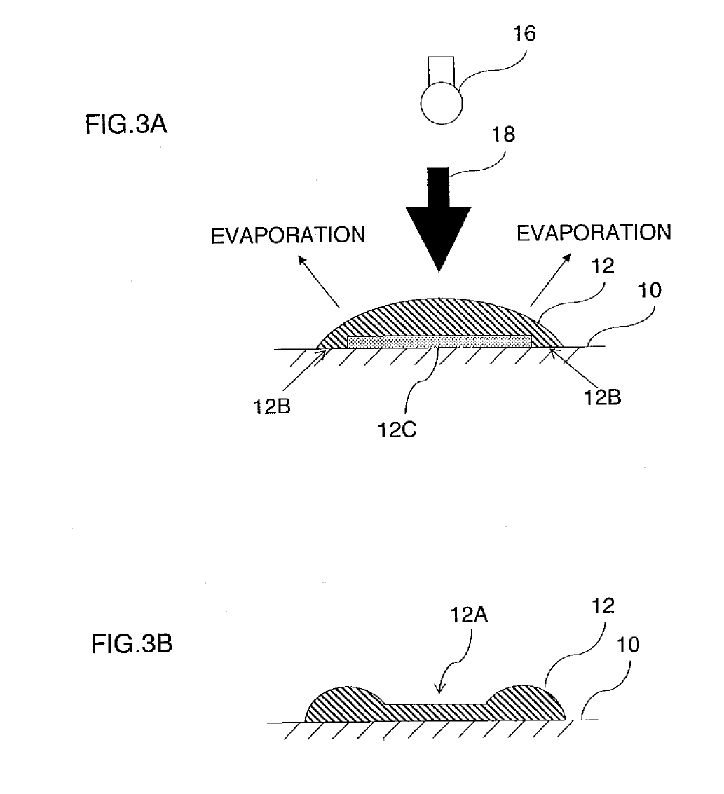

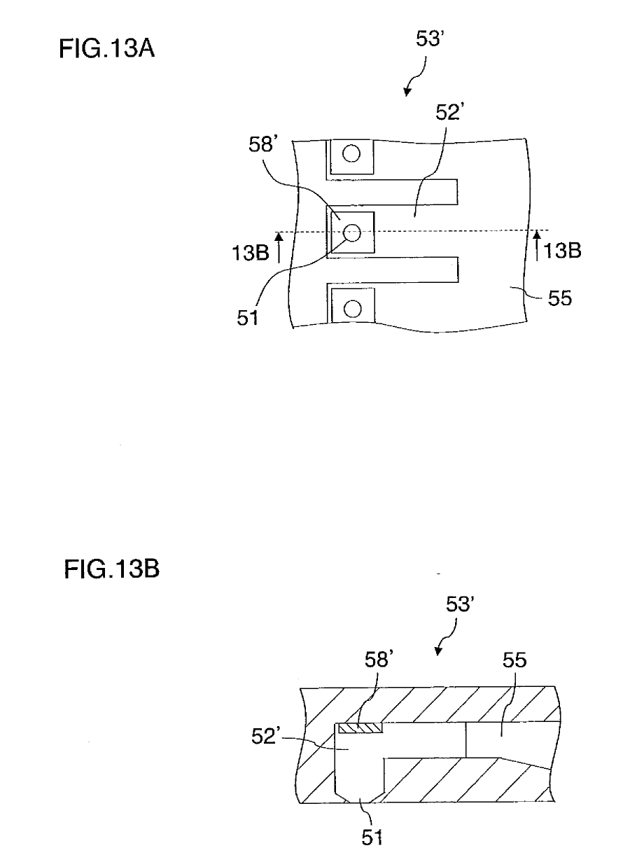

FIG. 3A shows a state where a beam of ultraviolet (UV) light 18 is irradiated by a light source 16 from directly above (the upper side) of the droplet 12, and FIG. 13B shows the droplet 12 that has solidified in a state where the recess portion 12A is formed on the upper surface of the droplet 12.

The ultraviolet light 18 shown in FIG. 3A has sufficient strength to cause the liquid forming the droplet 12 to evaporate, and the ultraviolet light 18 is irradiated onto a prescribed region centered on the central portion of the droplet 12. Since the intensity of the light beam generally has a Gaussian distribution, then due to the irradiation of the ultraviolet light onto the droplet 12 in this way, in the central portion of the droplet 12 (the region where the ultraviolet light 18 is irradiated strongly), the solvent component on the surface evaporates off (represented with the arrowed lines in the drawing). On the other hand, in the peripheral region 12B of the droplet 12, the intensity of the ultraviolet light 18 is sufficiently smaller compared to the central portion (or alternatively, the ultraviolet light 18 does not strike the peripheral region), and therefore evaporation of the solvent component does not occur in the peripheral region 12B of the droplet 12. Moreover, since the curing (solidification) reaction caused by the ultraviolet light occurs more readily if oxygen is not present, then solidification occurs from the lower potion 12C of the droplet 12 (the portion represented with the dot hatching in the drawing, which lies in contact with the medium 10). The combined effect of these two phenomena causes the central portion to assume the depressed state when the droplet 12 solidifies.

In respect of the conditions of the solidification process carried out by the irradiation of ultraviolet light, if the ratio between the diameter of the beam (e.g., of laser) of ultraviolet light and the diameter of the droplet being subjected to solidification is 1:3, then a desirable solidification process is achieved (namely, a solidification process in which the upper surface retains a depressed shape). Since it can be envisaged that the central portion of the droplet will be sunken to a larger degree, the greater the diameter of the droplet being solidified, then it is desirable that the ratio of (“the diameter of the droplet being solidified”/“the diameter of the light beam”) is not smaller than ⅓. However, from the viewpoint of stacking up the droplets, it is desirable that the surface area of the bottom surface of the recess portion 12A is larger. Therefore, it is desirable to make the diameter of the light beam larger, and consequently it is more desirable that the ratio of (“the diameter of the droplet being solidified”/“the diameter of the light beam”) is approximately ⅓.

### Specific Embodiment 2

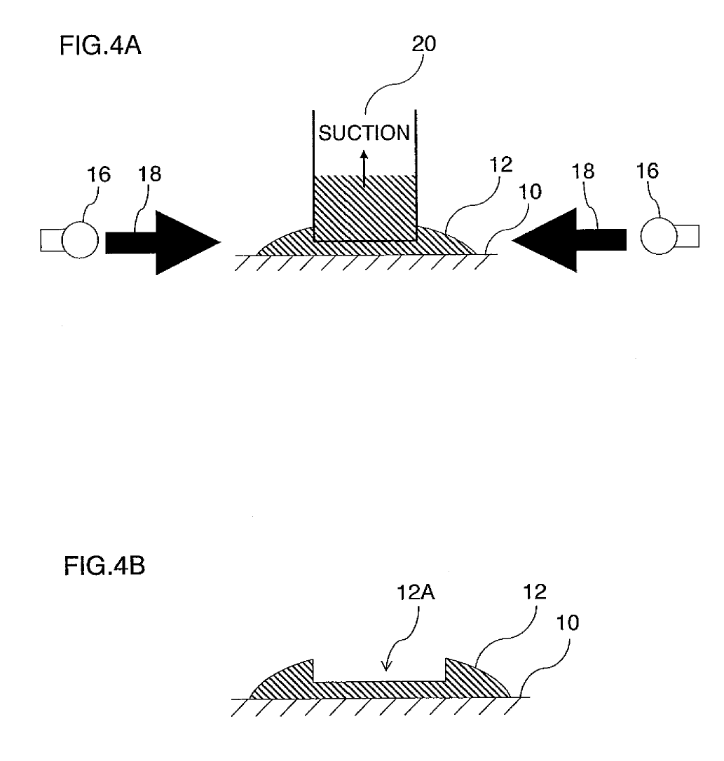

FIGS. 4A and 4B show a further mode of the solidification process illustrated in FIGS. 3A and 3B. FIG. 4A shows a schematic drawing of a state where a needle 20 (for example, a syringe needle) having a hollow cylindrical shape is inserted into the central portion of the droplet 12 and the ultraviolet light 18 is irradiated to the side faces of the liquid droplet 12. In the state shown in FIG. 4A, the droplet 12 becomes solidified from the periphery and the ultraviolet light does not strike the portion where the needle 20 is inserted (the inner portion of the needle 20) and hence this portion of the liquid does not solidify. Subsequently, the residual liquid component in the portion where the needle 20 is inserted and the droplet has not solidified is removed, and as shown in FIG. 4B, the droplet 12 solidifies with a shape having the recess portion 12A.

The outer diameter of the needle 20 is subjected to the same conditions as those of the diameter of the light beam described with reference to FIGS. 3A and 3B, and hence desirably the ratio of (“the diameter of the droplet to be solidified”/“the outer diameter of needle”) is not smaller than ⅓, and more desirably, the ratio of (“the diameter of the droplet to be solidified”/“the outer diameter of needle”) is approximately ⅓.

The suctioning of the portion where the needle 20 is inserted may employ natural suctioning by capillary action, or suction by means of a suction syringe, or the like.

It is also possible to simultaneously solidify a plurality of droplets using the solidification processing method shown in FIGS. 4A and 4B. For example, there are provided a needle supporting body, which supports from above m (m being an integer larger than 1) needles 20 arranged equidistantly at intervals the same as m droplets that are arranged equidistantly on the medium 10; a needle supporting body moving mechanism, which moves the needle supporting body so as to traverse the medium 10; and an elevator mechanism, which raises and lowers the needle supporting body, and when the m droplets arranged in one row have been deposited, the needle supporting body is moved to a position directly above the row of droplets by means of the needle supporting body moving mechanism, and the needle supporting body is then lowered, thereby inserting the m needles simultaneously into the m droplets, and in this state, the ultraviolet light is irradiated onto the m droplets. When the solidification process for one row has been completed, the droplet deposition process and the solidification process are carried out for the next row, and by repeating these processes subsequently a pattern of the first droplets is formed on the medium 10. Then, by repeating the same processes as those of the first droplets, for second droplets and subsequent droplets, a three-dimensional pattern is formed on the medium 10. It is also possible to adopt a mode in which the solidification process is carried out while moving the needles of a smaller number than the number of droplets so as to two-dimensionally traverse the medium 10.

More specifically, when droplets are deposited onto the medium 10 using a head in which m nozzles are arranged in the prescribed direction (see the head block 50A shown in FIG. 5) while moving the head in the direction perpendicular to the prescribed direction, then by providing the needle supporting body in which the m needles 20 are arranged in the prescribed direction and carrying out the solidification process while moving the needle supporting body to follow the head to traverse the medium 10, it is possible to form a three-dimensional pattern by repeating the droplet deposition and solidification processes n times.

### <Ultraviolet-Solidifiable Liquid>

Next, materials which are solidified by irradiation of ultraviolet light are described below.

The ink composition applicable in the present invention (hereinafter, also called simply an “ink”) comprises (A) an N-vinyllactam, (B) a monomer represented by Formula (I) or Formula (II), and (C) a radical polymerization initiator

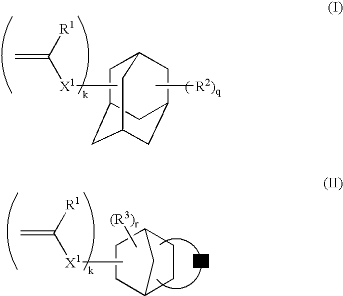

(In Formula (I) and Formula (II), R¹ denotes a hydrogen atom, a halogen atom, or an alkyl group having 1 to 4 carbons, X¹ denotes a divalent linking group, R² and R³ independently denote a substituent, k denotes an integer of 1 to 6, q and r independently denote an integer of 0 to 5, n denotes a cyclic hydrocarbon structure, the cyclic hydrocarbon structure may comprise in addition to hydrocarbon bonds a carbonyl bond (—C(O)—) and/or an ester bond (—C(O)O—), and the k R¹s, the k X¹s, the q R²s, and the r R³s may each be identical to or different from each other; furthermore, one carbon atom in the adamantane framework in Formula (I) may be replaced by a carbonyl bond (—C(O)—) and/or an ester bond (—C(O)O—), and one carbon atom in the norbornene framework in Formula (II) may be replaced by an ether bond (—O—) and/or an ester bond (—C(O)O—).)

Furthermore, the ink composition applicable in the present invention preferably comprises (D) a colorant, (E) a dispersant, and/or (F) a surfactant.

The “radiation” referred to in the present specification is not particularly limited as long as it is actinic radiation that can provide energy that enables an initiating species to be generated in the ink composition when irradiated, and broadly includes α rays, γ rays, X rays, ultraviolet rays (UV), visible light, and an electron beam; among these, ultraviolet rays and an electron beam are preferable from the viewpoint of curing sensitivity and the availability of equipment, and ultraviolet rays are particularly preferable. The ink composition applicable in the present invention is therefore preferably an ink composition that can cure upon exposure to ultraviolet rays as radiation.

### (A) N-Vinyllactam

The ink composition applicable in the present invention comprises an N-vinyllactam (hereinafter, also called component (A)).

Preferred examples of N-vinyllactams that are applicable in the present invention include compounds represented by Formula (A-1) below.

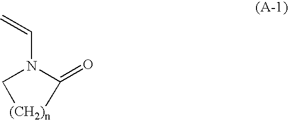

In Formula (A-1), n denotes an integer of 1 to 5; n is preferably an integer of 2 to 4 from the viewpoints of flexibility after the ink composition is cured, adhesion to a recording medium, and starting material availability, n is more preferably 2 or 4, and n is particularly preferably 4, which is N-vinylcaprolactam. N-Vinylcaprolactam is preferable since it has excellent safety, is commonly used and easily available at a relatively low price, and gives particularly good ink curability and adhesion of a cured film to a recording medium.

The N-vinyllactam may have a substituent such as an alkyl group or an aryl group on the lactam ring, and may have a saturated or unsaturated ring structure bonded thereto.

The ink composition applicable in the present invention preferably comprises the N-vinyllactam at least 5 wt % of the entire ink, more preferably at least 5 wt % but no greater than 40 wt %, and yet more preferably at least 10 wt % but no greater than 40 wt %. When the amount of N-vinyllactam used is in the above-mentioned range, the curability, the flexibility of a cured film, and the adhesion to a substrate of a cured film are excellent.

The N-vinyllactam is a compound having a relatively high melting point. It is preferable for the content of the N-vinyllactam to be no greater than 40 wt % since good solubility is exhibited even at a low temperature of 0° C. or less and the temperature range in which the ink composition can be handled becomes large.

The N-vinyllactam may be contained in the ink composition singly or in a combination of a plurality of types thereof.

### (B) Monomer Represented by Formula (I) or Formula (II)

The ink composition applicable in the present invention comprises the monomer represented by Formula (I) or Formula (II) (hereinafter, also called component (B)). The monomer represented by Formula (I) or Formula (II) is preferably an addition polymerizable monomer, and more preferably a radically polymerizable monomer

R¹ in Formula (I) or Formula (II) denotes a hydrogen atom, a halogen atom, or an alkyl group having 1 to 4 carbons, is preferably a hydrogen atom or an alkyl group having 1 to 4 carbons from the viewpoint starting material availability, and is more preferably a hydrogen atom or a methyl group. Furthermore, the k R¹s may be identical to or different from each other.

X¹ in Formula (I) or Formula (II) denotes a divalent linking group, and is preferably an ether group (—O—), an ester group (—C(O)O— or —OC(O)—), an amide group (—C(O)NR′—), a carbonyl group (—C(O)—), a nitrogen atom (—NR′—), an optionally substituted alkylene group having 1 to 15 carbons, or a divalent group in which 2 or more thereof are combined. Moreover, R′ denotes a hydrogen atom, a straight-chain, branched, or cyclic alkyl group having 1 to 20 carbons, or an aryl group having 6 to 20 carbons. The k X¹s may be identical to or different from each other.

Furthermore, a terminal portion of X¹ that is bonded to the vinyl group in Formula (I) or Formula (II) is preferably an ester group or amide group in which a carbonyl carbon of X¹ and a vinyl group are bonded, and in this case another portion of X¹ that is bonded to the adamantane framework or the norbornene framework may be a single bond or may be selected freely from the above-mentioned groups.

The substitution number k of the vinyl portion (H₂C═C(R¹)—X¹—) containing R¹ and X¹ in Formula (I) or Formula (II) denotes an integer of 1 to 6. The vinyl portion containing R¹ and X¹ may be bonded at any position to each alicyclic hydrocarbon structure. Here, “to each alicyclic hydrocarbon structure” means to the adamantane structure in Formula (I), to the norbornene structure in Formula (II), and to the cyclic hydrocarbon structure containing n.

Furthermore, from the viewpoint of improving the affinity with a colorant, a terminal portion of X¹ that is bonded to the alicyclic hydrocarbon structure in Formula (I) or Formula (II) is preferably an oxygen atom, and more preferably an ether type oxygen atom, and X¹ in Formula (I) or Formula (II) is yet more preferably —C(O)O(CH₂CH₂O)ₚ—(p denotes 1 or 2).

R² and R³ in Formula (I) or Formula (TI) independently denote a substituent that may be bonded to any position on each of the alicyclic hydrocarbon structures. Furthermore, the q R²s and the r R³s may each be identical to or different from each other.

The q R²s and the r R³s may independently be a monovalent or polyvalent substituent; the monovalent substituent is preferably a hydrogen atom, a hydroxyl group, a substituted or unsubstituted amino group, a thiol group, a siloxane group, or an optionally substituted hydrocarbon group or heterocyclic group having a total number of carbons of 30 or less, and a divalent substituent is preferably an oxy group (═O).

The substitution number q for R² denotes an integer of 0 to 5, and the substitution number r for R³ denotes an integer of 0 to 5.

n in Formula (II) denotes a cyclic hydrocarbon structure; opposite ends thereof may substitute any position of the norbornene framework, it may be a monocyclic structure or a polycyclic structure, and it may comprise as the cyclic hydrocarbon structure a carbonyl bond (—C(O)—) and/or an ester bond (—C(O)O—) in addition to hydrocarbon bonds.

Furthermore, one carbon atom of the adamantane framework in Formula (I) may be replaced by a carbonyl bond (—C(O)—) and/or an ester bond (—C(O)O—), and one carbon atom of the norbornene framework in Formula (II) may be replaced by an ether bond (—O—) and/or an ester bond (—C(O)O—).

The monomer represented by Formula (I) or Formula (II) is preferably a monomer represented by Formula (III), Formula (IV), or Formula (V).

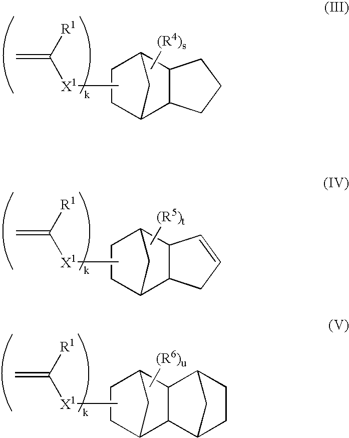

(In Formula (III), Formula (IV), and Formula (V), R¹ denotes a hydrogen atom, a halogen atom, or an alkyl group having 1 to 4 carbons, X¹ denotes a divalent linking group, R⁴, R⁵, and R⁶ independently denote a substituent, k denotes an integer of 1 to 6, s, t, and u independently denote an integer of 0 to 5, and the s R⁴s, the t R⁵s, and the u R⁶s may each be identical to or different from each other.)

R¹, X¹, and k in Formula (III), Formula (IV), or Formula (V) have the same meanings as those for R¹, X¹, and k in Formula (I) or Formula (II), and preferred ranges are also the same.

The vinyl portion containing R¹ and X¹ in Formula (III), Formula (IV), or Formula (V) may be bonded to any position on each of the alicyclic hydrocarbon structures shown below in Formula (III), Formula (IV), or Formula (V).

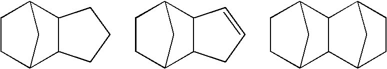

R⁴, R⁵, and R⁶ in Formula (III), Formula (IV), and Formula (V) independently denote a substituent, and may be bonded to any position of the respective alicyclic hydrocarbon structures in Formula (III), Formula (IV), and Formula (V). The substituents R⁴, R⁵, and R⁶ have the same meaning as that of the substituents R² and R³ of Formula (I) or Formula (II), and preferred ranges are also the same.

s, t, and u in Formula (III), Formula (IV), or Formula (V) independently denote an integer of 0 to 5, and the s R⁴s, the t R⁵s, and the u R⁶s may each be identical to or different from each other.

As the monomer represented by Formula (I) or Formula (II), specific preferred examples of monofunctional acrylates are shown below.

In some of the compound examples below, a hydrocarbon chain is expressed by a simplified structural formula in which symbols for carbon (C) and hydrogen (H) are omitted.

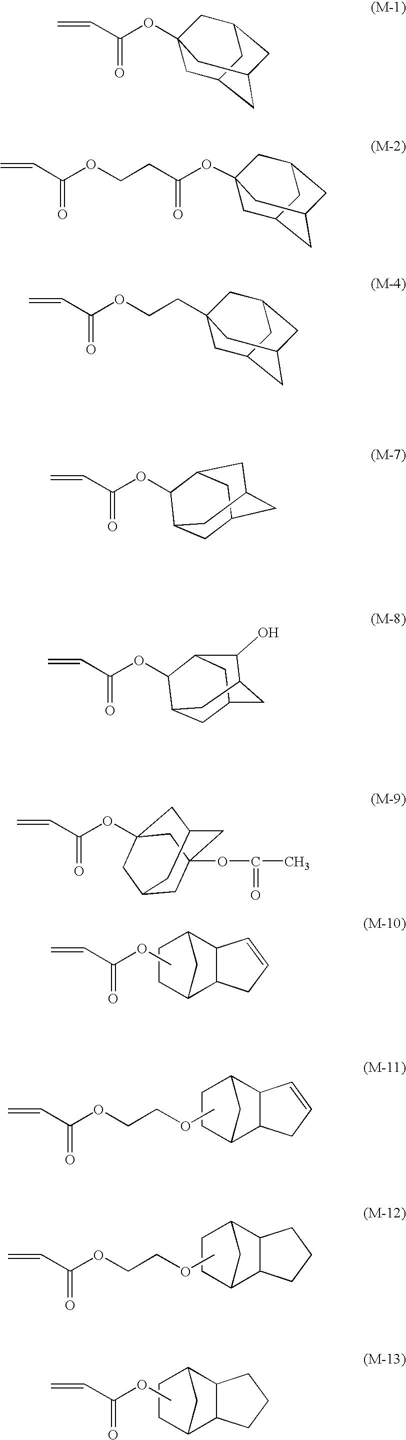

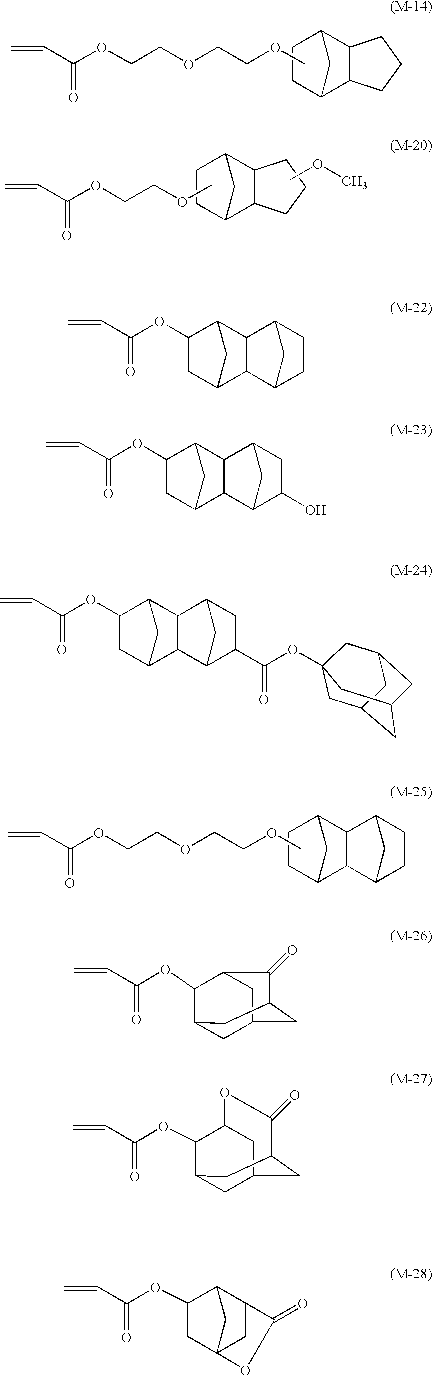

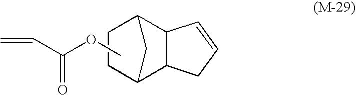

As the monomer represented by Formula (I) or Formula (II), specific preferred examples of monofunctional methacrylates are shown below.

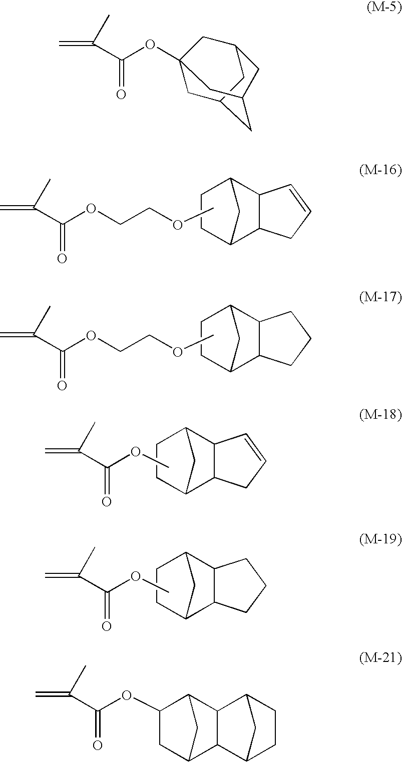

As the monomer represented by Formula (I) or Formula (II), specific preferred examples of monofunctional acrylamides are shown below.

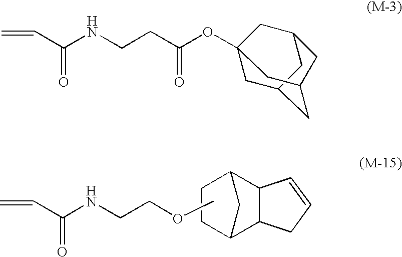

As the monomer represented by Formula (I) or Formula (II), specific preferred examples of monofunctional vinyl ethers are shown below.

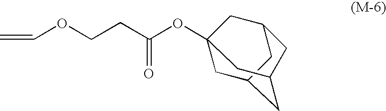

Specific preferred examples of polyfunctional acrylates represented by Formula (I) or Formula (II) are shown below.

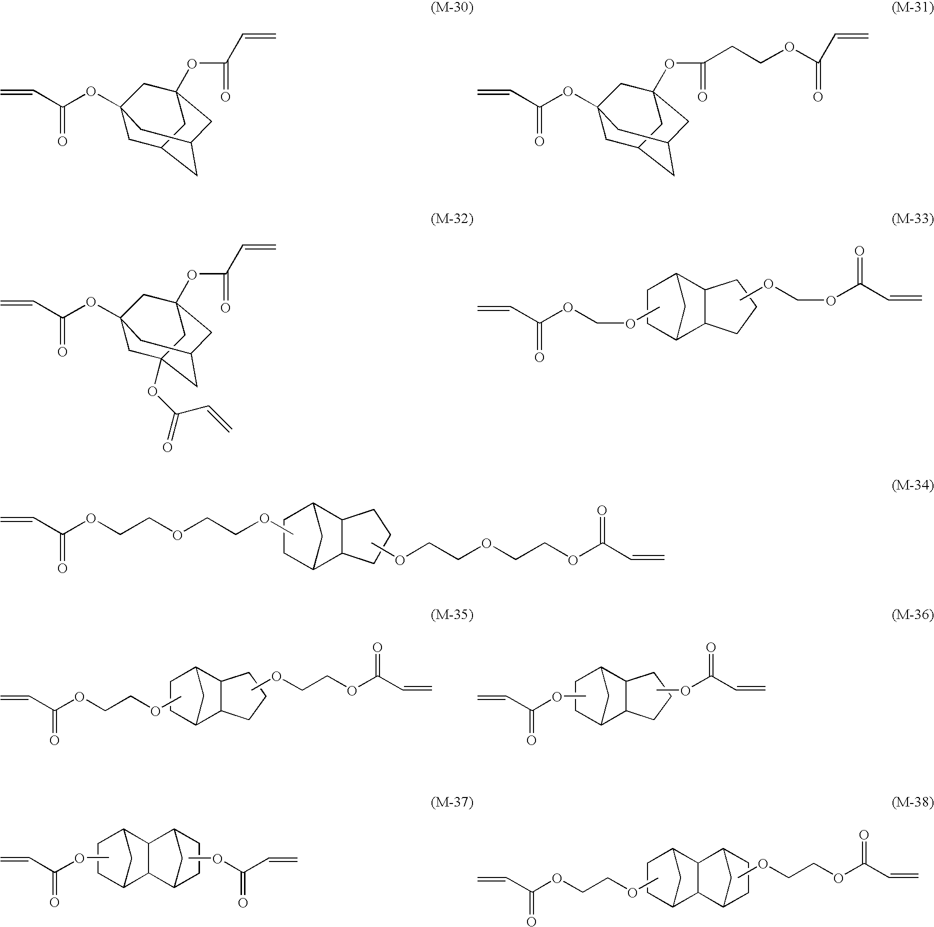

Specific preferred examples of polyfunctional methacrylates represented by Formula (I) or Formula (II) are shown below.

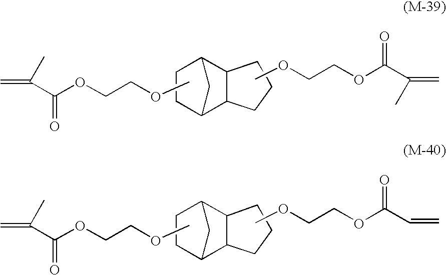

Among these monofunctional monomers and polyfunctional monomers, it is particularly preferable to use, as the monomer (B) represented by Formula (I) or Formula (II) in the ink composition applicable in the present invention, M-1, M-10, M-11, M-12, M-13, M-16, or M-35.

The amount of monomer (B) represented by Formula (I) or Formula (II) in the ink composition applicable in the present invention is preferably 0.5 to 90 wt % relative to the total amount of the ink composition, more preferably 2 to 70 wt %, and yet more preferably 10 to 50 wt %. It is preferable for the amount to be in the above-mentioned range since the curability is excellent and the viscosity is appropriate.

It is preferable that at least one of the monomers (B) represented by Formula (I) or Formula (II) in the ink composition applicable in the present invention is a monofunctional monomer, and it is more preferable that at least one thereof is a monofunctional acrylate. It is preferable to use a monofunctional monomer since sufficient flexibility for a cured film as well as sufficient curability can be obtained.

When the ink composition applicable in the present invention comprises a monofunctional acrylate, a monofunctional methacrylate, a monofunctional acrylamide, or a monofunctional vinyl ether represented by Formula (I) or Formula (II), the proportion of the monofunctional acrylate, the monofunctional methacrylate, the monofunctional acrylamide, or the monofunctional vinyl ether in the ink composition is preferably 1 to 90 wt %, more preferably 2 to 70 wt %, and yet more preferably 10 to 50 wt %. It is preferable for the proportion to be in the above-mentioned range since the curability and flexibility are excellent and the viscosity is appropriate.

When the ink composition applicable in the present invention comprises a monomer having at least two functional groups, selected from an acrylate, a methacrylate, and an acrylamide represented by Formula (I) or Formula (II), the proportion of the monomer in the ink composition is preferably 0.5 to 15 wt %, more preferably 0.5 to 10 wt %, and yet more preferably 0.5 to 5 wt %. It is preferable for the proportion to be in the above-mentioned range since the curability and flexibility are excellent and the viscosity is appropriate.

The proportion of a polyfunctional acrylate having at least two acrylate groups in the ink composition applicable in the present invention is preferably 0 to 15 wt %, more preferably 0 to 10 wt %, and yet more preferably 0 to 5 wt %. When the proportion is in the above-mentioned range, an ink composition that gives a cured film having excellent flexibility can be provided.

### (C) Radical Polymerization Initiator

The ink composition applicable in the present invention comprises a radical polymerization initiator.

As a polymerization initiator that is applicable in the present invention, a known radical polymerization initiator may be used, and it is preferable to use a radical polymerization initiator. The radical polymerization initiator that is applicable in the present invention may be used singly or in a combination of two or more types. Furthermore, the radical polymerization initiator may be used in combination with a cationic polymerization initiator.

The polymerization initiator that can be used in the ink composition applicable in the present invention is a compound that forms a polymerization initiating species by absorbing external energy. The external energy used for initiating polymerization can be broadly divided into heat and actinic radiation, and a thermal polymerization initiator and a photopolymerization initiator are used respectively. Examples of the actinic radiation include γ rays, β rays, an electron beam, ultraviolet rays, visible light, and infrared rays. In the ink composition applicable in the present invention, the external energy used for initiating polymerization is preferably actinic radiation, more preferably the electron beam or ultraviolet rays, and yet more preferably ultraviolet rays.

Examples of the radical polymerization initiator that is applicable in the present invention include (a) an aromatic ketone, (b) an acylphosphine compound, (c) an aromatic onium salt compound, (d) an organic peroxide, (e) a thio compound, (f) a hexaarylbiimidazole compound, (g) a ketoxime ester compound, (h) a borate compound, (i) an azinium compound, (j) a metallocene compound, (k) an active ester compound, (l) a compound having a carbon-halogen bond, and (m) an alkylamine compound. With regard to these radical polymerization initiators, the above-mentioned compounds (a) to (m) may be used singly or in combination. The radical polymerization initiator applicable in the present invention may suitably be used singly or in a combination of two or more types.

Preferred examples of the aromatic ketone (a) and the thio compound (e) include a compound having a benzophenone skeleton (benzophenone compound) or a compound having a thioxanthone skeleton (thioxanthone compound) described in “RADIATION CURING IN POLYMER SCIENCE AND TECHNOLOGY” J. P. FOUASSIER and J. F. RABEK (1993), pp. 77 to 117. Preferred examples of the aromatic ketone (a), the acylphosphine compound (b), and the thio compound (e) include an α-thiobenzophenone compound described in JP-B-47-6416, a benzoin ether compound described in JP-B-47-3981, an α-substituted benzoin compound described in JP-B-47-22326, a benzoin derivative described in JP-B-47-23664, an aroylphosphonic acid ester described in JP-A-57-30704, a dialkoxybenzophenone described in JP-B-60-26483, benzoin ethers described in JP-B-60-26403 and JP-A-62-81345, α-aminobenzophenones described in JP-B-1-34242, U.S. Pat. No. 4,318,791, and EP No. 0284561A1, p-di(dimethylaminobenzoyl)benzene described in JP-A-2-211452, a thio-substituted aromatic ketone described in JP-A-61-194062, an acylphosphine sulfide described in JP-B-2-9597, an acylphosphine described in JP-B-2-9596, a thioxanthone described in JP-B-63-61950, and a coumarin described in JP-B-59-42864.

As the aromatic onium salt compound (c), there can be cited aromatic onium salts of elements of Groups 15, 16, and 17 of the periodic table, specifically, N, P, As, Sb, Bi, O, S, Se, Te, and I. Examples thereof include iodonium salts described in EP No. 104143, U.S. Pat. No. 4,837,124, JP-A-2-150848, and JP-A-2-96514, diazonium salts (optionally substituted benzenediazoniums, etc.) described in EP Nos. 370693, 233567, 297443, 297442, 279210, and 422570, U.S. Pat. Nos. 3,902,144, 4,933,377, 4,760,013, 4,734,444, and 2,833,827, diazonium salt resins (diazodiphenylamine formaldehyde resins, etc.), N-alkoxypyridinium salts, etc. (e.g. those described in U.S. Pat. No. 4,743,528, JP-A-63-138345, JP-A-63-142345, JP-A-63-142346, and JP-B-46-42363; specific examples thereof include 1-methoxy-4-phenylpyridinium tetrafluoroborate); furthermore, compounds described in JP-B-52-147277, 52-14278, and 52-14279 may suitably be used. A radical or an acid is formed as an active species.

As the organic peroxide (d), almost all organic compounds having at least one oxygen-oxygen bond per molecule can be cited, and preferred examples thereof include peroxide ester compounds such as 3,3′,4,4′-tetra(t-butylperoxycarbonyl)benzophenone, 3,3′,4,4′-tetra(t-amylperoxycarbonyl)benzophenone, 3,3′,4,4′-tetra(t-hexylperoxycarbonyl)benzophenone, 3,3′,4,4′-tetra(t-octylperoxycarbonyl)benzophenone, 3,3′,4,4′-tetra(cumylperoxycarbonyl)benzophenone, 3,3′,4,4′-tetra(p-isopropylcumylperoxycarbonyl)benzophenone, and di-t-butyldiperoxyisophthalate.

As the hexaarylbiimidazole compound (1), there can be cited lophine dimers described in JP-B-45-37377 and JP-B-44-86516, and examples thereof include 2,2′-bis(o-chlorophenyl)-4,4′,5,5′-tetraphenylbiimidazole, 2,2′-bis(o-bromophenyl)-4,4′,5,5′-tetraphenylbiimidazole, 2,2′-bis(o,p-dichlorophenyl)-4,4′,5,5′-tetraphenylbiimidazole, 2,2′-bis(o-chlorophenyl)-4,4′,5,5′-tetra(m-methoxyphenyl)biimidazole, 2,2′-bis(o,o′-dichlorophenyl)-4,4′,5,5′-tetraphenylbiimidazole, 2,2′-bis(o-nitrophenyl)-4,4′,5,5′-tetraphenylbiimidazole, 2,2′-bis(o-methylphenyl)-4,4′,5,5′-tetraphenylbiimidazole, and 2,2′-bis(o-trifluorophenyl)-4,4′,5,5′-tetraphenylbiimidazole.

As the ketoxime ester compound (g), there can be cited 3-benzoyloxyiminobutan-2-one, 3-acetoxyiminobutan-2-one, 3-propionyloxyiminobutan-2-one, 2-acetoxyiminopentan-3-one, 2-acetoxyimino-1-phenylpropan-1-one, 2-benzoytoxyimino -1-phenylpropan-1-one, 3-p-toluenesulfonyloxyiminobutan-2-one, and 2-ethoxycarbonyloxyimino-1-phenylpropan-1-one.

Examples of the borate compound (h) include compounds described in U.S. Pat. Nos. 3,567,453 and 4,343,891, and EP Nos. 109,772 and 109,773.

Examples of the azinium compound (i) include N—O bond-containing compounds described in JP-A-63-138345, JP-A-63-142345, JP-A-63-142346, JP-A-63-143537, and JP-B-46-42363.

Examples of the metallocene compound (j) include titanocene compounds described in JP-A-59-152396, JP-A-61-151197, JP-A-63-41484, JP-A-2-249, and JP-A-2-4705, and iron-arene complexes described in JP-A-1-304453 and JP-A-1-152109.

Specific examples of the titanocene compound include dichlorobis(cyclopentadienyl)titanium, bis(cyclopentadienyl)bis(phenyl)titanium, bis(cyclopentadienyl)bis(2,3,4,5,6-pentafluorophen-1-yl)titanium, bis(cyclopentadienyl)bis(2,3,5,6-tetrafluorophen-1-yl)titanium, bis(cyclopentadienyl)bis(2,4,6-trifluorophen-1-yl)titanium, bis(cyclopentadienyl)bis(2,6-difluorophen-1-yl)titanium, bis(cyclopentadienyl)bis(2,4-difluorophen-1-yl)titanium, bis(methylcyclopentadienyl)bis(2,3,4,5,6-pentafluorophen-1-yl)titanium, bis(methylcyclopentadienyl)bis(2,3,5,6-tetrafluorophen-1-yl)titanium, bis(methylcyclopentadienyl)bis(2,4-difluorophen-1-yl)titanium, bis(cyclopentadienyl)bis[2,6-difluoro-3-(pyrr-1-yl)phenyl]titanium, bis(cyclopentadienyl)bis[2,6-difluoro-3-(methylsulfonamido)phenyl]titanium, and to bis(cyclopentadienyl)bis[2,6-difluoro-3-N-butylbiaroylamino)phenyl]titanium.

Examples of the active ester compound (k) include nitrobenzyl ester compounds described in EP Nos. 0290750, 046083, 156153, 271851, and 0388343, U.S. Pat. Nos. 3,901,710 and 4,181,531, JP-A-60-198538, and JP-A-53-133022, iminosulfonate compounds described in EP Nos. 0199672, 84515, 199672, 044115, and 0101122, U.S. Pat. Nos. 4,618,564, 4,371,605, and 4431774, JP-A-64-18143, JP-A-2-245756, and JP-A-4-365048, and compounds described in JP-B-62-6223, JP-B-63-14340, and JP-A-59-174831.

Preferred examples of the compound (l) having a carbon-halogen bond include a compound described in Wakabayashi et. al, Bull. Chem. Soc. Japan, 42, 2924 (1969), a compound described in British Patent No. 1388492, a compound described in JP-A-53-133428, and a compound described in German Patent No. 3337024.

Examples further include a compound described in F. C. Schaefer et al., J. Org. Chem., 29, 1527 (1964), a compound described in JP-A-62-58241, a compound described in JP-A-5-281728, a compound described in German Pat. No. 2641100, a compound described in German Pat. No. 3333450, compounds described in German Pat. No. 3021590, and compounds described in German Pat. No. 3021599.

In the ink composition applicable in the present invention, the total amount of radical polymerization initiator used is preferably 0.01 to 35 wt % relative to the total amount of polymerizable compound, including an N-vinyllactam and a monomer represented by Formula (I) or Formula (II), used, more preferably 0.5 to 20 wt %, and yet more preferably 1.0 to 15 wt %. The ink composition can be cured with 0.01 wt % or greater of the polymerization initiator, and a cured film having a uniform degree of curing can be obtained with 35 wt % or less.

Furthermore, when a sensitizing dye, which will be described later, is used in the ink composition applicable in the present invention, the total amount of radical polymerization initiator used is preferably 200:1 to 1:200 relative to the sensitizing dye as a ratio by weight of polymerization initiator:sensitizing dye, more preferably 50:1 to 1:50, and yet more preferably 20:1 to 1:5.

### (D) Colorant

Although it is not particularly necessary to form a colored image when the ink composition applicable in the present invention is used for formation of an image area of a lithographic printing plate, etc., in order to improve the visibility of an image area that is formed or in an attempt to form a colored image using the ink composition, it may contain a colorant.

The colorant that is applicable in the present invention is not particularly limited, but a pigment and an oil-soluble dye that have excellent weather resistance and rich color reproduction are preferable, and it may be selected from any known colorant such as a soluble dye. It is preferable that the colorant that can be suitably used in the ink composition or the inkjet recording ink composition applicable in the present invention does not function as a polymerization inhibitor in a polymerization reaction, which is a curing reaction. This is because the sensitivity of the curing reaction by actinic radiation should not be degraded.

### (a) Pigment

The pigment that is applicable in the present invention is not particularly limited and, for example, organic and inorganic pigments having the numbers below described in the Color Index may be used.

That is, as a red or magenta pigment, Pigment Red 3, 5, 19, 22, 31, 38, 42, 43, 48:1, 48:2, 48:3, 48:4, 48:5, 49:1, 53:1, 57:1, 57:2, 58:4, 63:1, 81, 81:1, 81:2, 81:3, 81.4, 88, 104, 108, 112, 122, 123, 144, 146, 149, 166, 168, 169, 170, 177, 178, 179, 184, 185, 208, 216, 226, or 257, Pigment Violet 3, 19, 23, 29, 30, 37, 50, or 88, and Pigment Orange 13, 16, 20, or 36;

as a blue or cyan pigment, Pigment Blue 1, 15, 15:1, 15:2, 15:3, 15:4, 15:6, 16, 17-1, 22, 27, 28, 29, 36, or 60;

as a green pigment, Pigment Green 7, 26, 36, or 50;

as a yellow pigment, Pigment Yellow 1, 3, 12, 13, 14, 17, 34, 35, 37, 55, 74, 81, 83, 93, 94, 95, 97, 108, 109, 110, 120, 137, 138, 139, 153, 154, 155, 157, 166, 167, 168, 180, 185, or 193;

as a black pigment, Pigment Black 7, 28, or 26; and

as a white pigment, Pigment White 6, 18, or 21, etc. may be used according to the intended application.

### (b) Oil-Soluble Dye

The oil-soluble dye that is applicable in the present invention is explained below.

The oil-soluble dye that is applicable in the present invention means a dye that is substantially insoluble in water. Specifically, the solubility in water at 25° C. (the mass of dye that can be dissolved in 100 g of water) is no greater than 1 g, preferably no greater than 0.5 g, and more preferably no greater than 0.1 g. Therefore, the oil-soluble dye means a so-called water-insoluble pigment or an oil-soluble dye, and among these the oil-soluble dye is preferable.

Among the oil-soluble dyes that is applicable in the present invention, as a yellow dye, any may be used. Examples thereof include aryl or heteryl azo dyes having a coupling component such as a phenol, a naphthol, an aniline, a pyrazolone, a pyridone, or an open-chain active methylene compound; azomethine dyes having a coupling component such as an open-chain active methylene compound; methine dyes such as benzylidene dyes and monomethineoxonol dyes; quinone dyes such as naphthoquinone dyes and anthraquinone dyes; and other dye species such as quinophthalone dyes, nitro/nitroso dyes, acridine dyes, and acridinone dyes.

Among the above-mentioned oil-soluble dyes that is applicable in the present invention, as a magenta dye, any may be used. Examples thereof include aryl or heteryl azo dyes having a coupling component such as a phenol, a naphthol, or an aniline; azomethine dyes having a coupling component such as a pyrazolone or a pyrazolotriazole; methine dyes such as arylidene dyes, styryl dyes, merocyanine dyes, and oxonol dyes; carbonium dyes such as diphenylmethane dyes, triphenylmethane dyes, and xanthene dyes; quinone dyes such as naplithoquinones, anthraquinones, or anthrapyridones; and condensed polycyclic dyes such as dioxazine dyes.

Among the oil-soluble dyes that is applicable in the present invention, as a cyan dye, any may be used. Examples thereof include indoaniline dyes, indophenol dyes, and azomethine dyes having a coupling component such as a pyrrolotriazole; polymethine dyes such as cyanine dyes, oxonol dyes, and merocyanine dyes; carbonium dyes such as diphenylmethane dyes, triphenylmethane dyes, and xanthene dyes; phthalocyanine dyes; anthraquinone dyes; aryl or heteryl azo dyes having a coupling component such as a phenol, a naphthol, or an aniline; and indigo/thioindigo dyes.

The above-mentioned dyes may be dyes that exhibit respective colors of yellow, magenta, and cyan only after a part of the chromophore dissociates, and in that case the counter cation may be an inorganic cation such as an alkali metal or ammonium, may be an organic cation such as pyridinium or a quaternary ammonium salt, or may be a polymer cation having the above cation as a partial structure.

Although not limited to the following, preferred specific examples thereof include CI Solvent Black 3, 7, 27, 29, and 34; CI Solvent Yellow 14, 16, 19, 29, 30, 56, 82, 93, and 162; CI Solvent Red 1, 3, 8, 18, 24, 27, 43, 49, 51, 72, 73, 109, 122, 132, and 218; CI Solvent Violet 3; CI Solvent Blue 2, 11, 25, 35, 38, 67, and 70; CI Solvent Green 3 and 7; and CI Solvent Orange 2.

Particularly preferred examples thereof include Nubian Black PC-0850, Oil Black HBB, Oil Yellow 129, Oil Yellow 105, Oil Pink 312, Oil Red 5B, Oil Scarlet 308, Vali Fast Blue 2606, Oil Blue BOS (manufactured by Orient Chemical Industries, Ltd.), Aizen Spilon Blue GNH (manufactured by Hodogaya Chemical Co., Ltd.), Neopen Yellow 075, Neopen Magenta SE1378, Neopen Blue 808, Neopen Blue FF4012, and Neopen Cyan FF4238 (manufactured by BASF).

In the ink composition applicable in the present invention, the oil-soluble dye may be used singly or in a combination of two or more types.

Furthermore, another colorant such as a water-soluble dye, a disperse dye, or a pigment may be contained as necessary in a range that does not interfere with the effects applicable in the present invention.

In the ink composition applicable in the present invention, a disperse dye may be used in a range that enables it to be dissolved in a water-immiscible organic solvent. Disperse dyes generally include water-soluble dyes, but in the ink composition applicable in the present invention it is preferable for the disperse dye to be used in a range such that it dissolves in a water-immiscible organic solvent. Specific preferred examples of the disperse dye include CI Disperse Yellow 5, 42, 54, 64, 79, 82, 83, 93, 99, 100, 119, 122, 124, 126, 160, 184:1, 186, 198, 199, 201, 204, 224, and 237; CI Disperse Orange 13, 29, 31:1, 33, 49, 54, 55, 66, 73, 118, 119, and 163; CI Disperse Red 54, 60, 72, 73, 86, 88, 91, 92, 93, 111, 126, 127, 134, 135, 143, 145, 152, 153, 154, 159, 164, 167:1, 177, 181, 204, 206, 207, 221, 239, 240, 258, 277, 278, 283, 311, 323, 343, 348, 356, and 362; CI Disperse Violet 33; CI Disperse Blue 56, 60, 73, 87, 113, 128, 143, 148, 154, 158, 165, 165:1, 165:2, 176, 183, 185, 197, 198, 201, 214, 224, 225, 257, 266, 267, 287, 354, 358, 365, and 368; and CI Disperse Green 6:1 and 9.

The colorant that is applicable in the present invention is preferably added to the ink composition or the inkjet recording ink composition applicable in the present invention and then dispersed in the ink to an appropriate degree. For dispersion of the colorant, for example, a dispersing machine such as a ball mill, a sand mill, an attritor, a roll mill, an agitator, a Henschel mixer, a colloidal mill, an ultrasonic homogenizer, a pearl mill, a wet type jet mill, or a paint shaker may be used.

The colorant may be added directly to the ink composition applicable in the present invention, but in order to improve dispersibility it may be added in advance to a solvent or a dispersing medium such as a radically polymerizable compound applicable in the present invention.

In the ink composition applicable in the present invention, in order to avoid the is problem of the solvent resistance being degraded when the solvent remains in the cured image and the VOC (Volatile Organic Compound) problem of the residual solvent, it is preferable to add the colorant in advance to a dispersing medium such as a radically polymerizable compound. As a polymerizable compound used, it is preferable in terms of dispersion suitability to select a monomer having the lowest viscosity.

These colorants may be used by appropriately selecting one type or two or more types according to the intended purpose of the ink composition.

When a colorant such as a pigment that is present as a solid in the ink composition applicable in the present invention is used, it is preferable for the colorant, the dispersant, the dispersing medium, dispersion conditions, and filtration conditions to be set so that the average particle size of colorant particles is preferably 0.005 to 0.5 μm, more preferably 0.01 to 0.45 μm, and yet more preferably 0.015 to 0.4 μm. By such control of particle size, clogging of a head nozzle can be suppressed, and the ink storage stability, the ink transparency, and the curing sensitivity can be maintained.

The content of the colorant in the ink composition applicable in the present invention is appropriately selected according to the color and the intended purpose, and is generally preferably 0.01 to 30 wt % relative to the weight of the entire ink composition.

### (E) Dispersant

It is preferable to add a dispersant when dispersing the colorant. The type of dispersant is not particularly limited, but it is preferable to use a polymeric dispersant. Examples of the polymeric dispersant include polymeric dispersants such as DisperBYK-101, DisperBYK-102, DisperBYK-103, DisperBYK-106, DisperBYK-111, DisperBYK-161, DisperBYK-162, DisperBYK-163, DisperBYK-164, DisperBYK-166, DisperBYK-167, DisperBYK-168, DisperBYK-170, DisperBYK-171, DisperBYK-174, and DisperBYK-182 (all manufactured by BYK Chemie), EFKA4010, EFKA4046, EFKA4080, EFKA5010, EFKA5207, EFKA5244, EFKA6745, EFKA6750, EFKA7414, EFKA7462, EFKA7500, EFKA7570, EFKA7575, and EFKA7580 (all manufactured by EFKA Additives), Disperse Aid 6, Disperse Aid 8, Disperse Aid 15, and Disperse Aid 9100 (manufactured by San Nopco Limited); various types of Solsperse dispersants such as Solsperse 3000, 5000, 9000, 12000, 13240, 13940, 17000, 24000, 26000, 28000, 32000, 36000, 39000, 41000, and 71000 (manufactured by Avecia); Adeka Pluronic L31, F38, L42, L44, L61, L64, F68, L72, P95, F77, P84, F87, P94, L101, P103, F108, L121, and P-123 (manufactured by Adeka Corporation), Isonet S-20 (manufactured by Sanyo Chemical Industries, Ltd.), and Disparlon KS-860, 873SN, and 874 (polymeric dispersant), #2150 (aliphatic poly carboxylic acid), and #7004 (polyether ester type) (manufactured by Kusumoto Chemicals, Ltd.).

It is also possible to use in combination a pigment derivative such as a phthalocyanine derivative (product name: EFKA-745 (manufactured by EFKA)), or Solsperse 5000, 12000, or 22000 (manufactured by Avecia).

The content of the dispersant in the ink composition applicable in the present invention is appropriately selected according to the intended purpose, and is generally preferably 0.01 to 5 wt % relative to the weight of the entire ink composition.

### (F) Surfactant

It is preferable to add a surfactant to the ink composition applicable in the present invention in order to impart long-term discharge stability.

As the surfactant, those described in JP-A-62-173463 and JP-A-62-183457 can be cited. Examples thereof include anionic surfactants such as dialkylsulfosuccinic acid salts, alkylnaphthalenesulfonic acid salts, and fatty acid salts, nonionic surfactants such as polyoxyethylene alkyl ethers, polyoxyethylene alkyl allyl ethers, acetylene glycols, and polyoxyethylene/polyoxypropylene block copolymers, and cationic surfactants such as alkylamine salts and quaternary ammonium salts. An organofluoro compound or a polysiloxane compound may be used as the above-mentioned surfactant. The organofluoro compound is preferably hydrophobic. Examples of the organofluoro compound include fluorine-based surfactants, oil-like fluorine-based compounds (e.g. fluorine oils), solid fluorine compound resins (e.g. tetrafluoroethylene resin), and those described in JP-B-57-9053 (columns 8 to 17) and JP-A-62-135826. As the polysiloxane compound, a modified polysiloxane compound in which an organic group is introduced into some methyl groups of dimethyl polysiloxane is preferable. Modification examples include polyether-modified, methylstyrene-modified, alcohol-modified, alkyl-modified, aralkyl-modified, fatty acid ester-modified, epoxy-modified, amine-modified, amino-modified, and mercapto-modified, but are not limited thereto. These methods for modification may be used in combination. Among them, polyether-modified polysiloxane compounds are preferable from the viewpoint of improvement in inkjet discharge stability. Examples of the polyether-modified polysiloxane compounds include SILWET L-7604, SILWET L-7607N, SILWET FZ-2104, and SILWET FZ-2161 (manufactured by Nippon Unicar Co., Ltd.), BYK-306, BYK-307, is BYK-331, BYK-333, BYK-347, and BYK-348 (manufactured by BYK Chemie), and KF-351A, KF-352A, KF-353, KF-354L, KF-355A, KF-615A, KF-945, KF-640, KF-642, KF-643, KF-6020, X-22-6191, X-22-4515, KF-6011, KF-6012, KF-6015, and KF-6017 (manufactured by Shin-Etsu Chemical Co., Ltd.).

The content of the surfactant in the ink composition applicable in the present invention is appropriately selected according to the intended purpose and is generally preferably 0.0001 to 1 wt % relative to the weight of the entire ink composition. Furthermore, these surfactants may be contained singly, or in a combination of two or more types of polysiloxane compounds.

### (G) Other Radically Polymerizable Compound

In the ink composition applicable in the present invention, in addition to components (A) and (B), another radically polymerizable compound (hereinafter, also called simply a “radically polymerizable compound”, which needless to say means a radically polymerizable compound other than components (A) and (B)), may be contained.

It is preferable to use a radically polymerizable compound in combination since an ink composition having better curability can be provided.

Examples of the radically polymerizable compound include photocurable materials employing photopolymerizable compositions described in JP-A-7-159983, JP-B-7-31399, JP-A-8-224982, JP-A-10-863, JP-A-9-80675, etc.

The radically polymerizable compound is a compound having a radically polymerizable ethylenically unsaturated bond, and may be any compound as long as it has at least one radically polymerizable ethylenically unsaturated bond in the molecule; examples thereof include those having a chemical configuration such as a monomer, an oligomer, or a polymer. One type of radically polymerizable compound may be used, or two or more types thereof may be used at any ratio in combination in order to improve an intended property.

Preferred examples of polymerizable compounds having a radically polymerizable ethylenically unsaturated bond include unsaturated carboxylic acids such as acrylic acid, methacrylic acid, itaconic acid, crotonic acid, isocrotonic acid, and maleic acid, and salts thereof, anhydrides having an ethylenically unsaturated group, acrylonitrile, styrene, and various types of unsaturated polyesters, unsaturated polyethers, unsaturated polyamides, and (meth)acrylic acid esters of unsaturated urethane (meth)acrylic monomers or prepolymers, epoxy monomers or prepolymers, or urethane monomers or prepolymers.

Specific examples thereof that can be used include acrylic acid derivatives such as (poly)ethylene glycol mono(meth)acrylate, poly)ethylene glycol (meth)acrylate methyl ester, (poly)ethylene glycol (meth)acrylate ethyl ester, (poly)ethylene glycol (meth)acrylate phenyl ester, (poly)propylene glycol mono(meth)acrylate, (poly)propylene glycol mono(meth)acrylate phenyl ester, (poly)propylene glycol (meth)acrylate methyl ester, (poly)propylene glycol (meth)acrylate ethyl ester, neopentyl glycol di(meth)acrylate, (poly)ethylene glycol di(meth)acrylate, (poly)tetramethylene glycol di(meth)acrylate, (poly)tetramethylene glycol di(meth)acrylate, bisphenol A propylene oxide(PO) adduct di(meth)acrylate, ethoxylated neopentyl glycol diacrylate, propoxylated neopentyl glycol diacrylate, bisphenol A ethylene oxide (EO) adduct di(meth)acrylate, EO-modified pentaerythritol triacrylate, PO-modified pentaerythritol triacrylate, EO-modified pentaerythritol tetraacrylate, PO-modified pentaerythritol tetraacrylate, EO-modified dipentaerythritol tetraacrylate, PO-modified dipentaerythritol tetraacrylate, EO-modified trimethylolpropane triacrylate, PO-modified trimethylolpropane triacrylate, EO-modified tetramethylolmethane tetraacrylate, PO-modified tetramethylolmethane tetraacrylate, 2-ethylhexyl acrylate, n-octyl acrylate, n-nonyl acrylate, n-decyl acrylate, isooctyl acrylate, n-lauryl acrylate, n-tridecyl acrylate, n-cetyl acrylate, n-stearyl acrylate, 2-hydroxyethyl acrylate, butoxyethyl acrylate, tetrahydrofurfuryl acrylate, benzyl acrylate, pentaerythritol triacrylate, pentaerythritol tetraacrylate, dipentaerythritol tetraacrylate, trimethylolpropane triacrylate, tetramethylolmethane tetraacrylate, oligoester acrylate, N-methylolacrylamide, diacetone acrylamide, and epoxy acrylate, methacrylic derivatives such as methyl methacrylate, n-butyl methacrylate, 2-ethylhexyl methacrylate, n-octyl methacrylate, n-nonyl methacrylate, n-decyl methacrylate, isooctyl methacrylate, n-lauryl methacrylate, n-tridecyl methacrylate, n-cetyl methacrylate, n-stearyl methacrylate, allyl methacrylate, glycidyl methacrylate, benzyl methacrylate, dimethylaminomethyl methacrylate, trimethylolethane trimethacrylate, trimethylolpropane trimethacrylate, and 2,2-bis(4-methacryloxypolyethoxyphenyl)propane, allyl compound derivatives such as allyl glycidyl ether, diallyl phthalate, and triallyl trimellitate, 1,6-hexanediol diacrylate, 1,9-nonanediol diacrylate, 1,10-decanediol diacrylate, 2-ethyihexyl-diglycol acrylate, 2-hydroxy-3-phenoxypropyl acrylate, 2-hydroxybutyl acrylate, hydroxypivalic acid neopentyl glycol diacrylate, 2-acryloyloxyethylphthalic acid, tetramethylolmethane triacrylate, 2-acryloyloxyethyl-2-hydroxyethylphthalic acid, dimethyloltricyclodecane diacrylate, ethoxylated phenyl acrylate, 2-acryloyloxyethylsuccinic acid, modified glycerol triacrylate, bisphenol A diglycidyl ether acrylic acid adduct, modified bisphenol A diacrylate, 2-acyloyloxyethylhexahydrophthalic acid, dipentaerythritol hexaacrylate, pentaerythritol triacrylate tolylene diisocyanate urethane prepolymer, lactone-modified flexible acrylate, butoxyethyl acrylate, pentaerythritol triacrylate hexamethylene diisocyanate urethane prepolymer, methoxydipropylene glycol acrylate, ditrimethylolpropane tetraacrylate, and pentaerythritol triacrylate hexamethylene diisocyanate urethane prepolymer and, more specifically, commercial products, radically polymerizable or crosslinking monomers, oligomers, and polymers known in the art such as those described in “Kakyozai Handobukku” (Crosslinking Agent Handbook), Ed. S. Yamashita (Taiseisha, 1981); “UV·EB Koka Handobukku (Genryou Hen)” (UV•EB Curing Handbook (Starting Materials) Ed. K. Kato (Kobunshi Kankoukai, 1985); “UV•EB Koka Gijutsu no Oyo to Shijyo” (Application and Market of UV•EB Curing Technology”, p. 79, Ed. Rad Tech (CMC, 1989); and E. Takiyama “Poriesuteru Jushi Handobukku” (Polyester Resin Handbook), (The Nikkan Kogyo Shimbun Ltd., 1988).

Furthermore, as the radically polymerizable compound, a vinyl ether compound is preferably used. Examples of vinyl ether compounds that can suitably be used include di- or tri-vinyl ether compounds such as ethylene glycol divinyl ether, diethylene glycol divinyl ether, triethylene glycol divinyl ether, propylene glycol divinyl ether, dipropylene glycol divinyl ether, butanediol divinyl ether, hexanediol divinyl ether, cyclohexanedimethanol divinyl ether, and trimethylolpropane trivinyl ether, and monovinyl ether compounds such as ethyl vinyl ether, n-butyl vinyl ether, isobutyl vinyl ether, octadecyl vinyl ether, cyclohexyl vinyl ether, hydroxybutyl vinyl ether, 2-ethylhexyl vinyl ether, cyclohexanedimethanol monovinyl ether, n-propyl vinyl ether, isopropyl vinyl ether, isopropenyl ether-O-propylene carbonate, dodecyl vinyl ether, diethylene glycol monovinyl ether, octadecyl vinyl ether, ethylene glycol monovinyl ether, triethylene glycol monovinyl ether, hydroxyethylmonovinyl ether, and hydroxynonylmonovinyl ether.

Among these vinyl ether compounds, divinyl ether compounds and trivinyl ether compounds are preferable from the viewpoint of curability, adhesion, and surface hardness, and divinyl ether compounds are particularly preferable. The vinyl ether compounds may be used singly or in a combination of two or more types as appropriate.

In the ink composition applicable in the present invention, the monomers listed above as the above-mentioned polymerizable compounds have high reactivity, low viscosity, and excellent adhesion to a recording medium.

The content of said other radically polymerizable compound in the ink composition is preferably at least 1 wt % but no greater than 70 wt %, and more preferably at least 1 wt % but no greater than 60 wt %.

In the ink composition applicable in the present invention, the radically polymerizable compound may be used in combination with an oligomer or a polymer. The oligomer referred to here means a compound having a molecular weight (a weight-average molecular weight for one having a molecular weight distribution) of 2,000 or greater, and the polymer referred to here means a compound having a molecular weight (a weight-average molecular weight for one having a molecular weight distribution) of 10,000 or greater. The oligomer and the polymer optionally have a radically polymerizable group. It is preferable for the oligomer and the polymer to have no more than 4 radically polymerizable groups per molecule (an average of no more than 4 over all the molecules contained for one having a molecular weight distribution) since an ink composition having excellent flexibility can be obtained. They can suitably be used from the viewpoint of adjusting the viscosity to a level most suitable for jetting the ink.

### (H) Other Component

The ink composition applicable in the present invention may comprise another component as necessary. Examples of the other component include a sensitizing dye, a cosensitizer, another polymerizable compound, another polymerization initiator, a UV absorber, an antioxidant, an antifading agent, a conductive salt, a solvent, a polymer compound, and a basic compound.

### Sensitizing Dye

The ink composition applicable in the present invention may contain a sensitizing dye in order to promote decomposition of the above-mentioned polymerization initiator by absorbing specific actinic radiation, in particular when used for inkjet recording. The sensitizing dye absorbs specific actinic radiation and attains an electronically excited state. The sensitizing dye in the electronically excited state causes actions such as electron transfer, energy transfer, or heat generation upon contact with the polymerization initiator. This causes the polymerization initiator to undergo a chemical change and decompose, thus forming a radical, an acid, or a base.

Preferred examples of the sensitizing dye include those that belong to compounds below and have an adsorption wavelength in the region of 350 nm to 450 nm.

Polynuclear aromatic compounds (e.g. pyrene, perylene, triphenylene), xanthenes (e.g. fluorescein, eosin, erythrosine, rhodamine B, rose bengal), cyanines (e.g. thiacarbocyanine, oxacarbocyanine), merocyanines (e.g. merocyanine, carbomerocyanine), thiazines (e.g. thionine, methylene blue, toluidine blue), acridines (e.g. acridine orange, chloroflavin, acriflavine), anthraquinones (e.g. anthraquinone), squaryliums (e.g. squarylium), and coumarins (e.g. 7-diethylamino-4-methylcoumarin).

Preferred examples of the sensitizing dye include compounds represented by Formulae (IX) to (XIII) below.

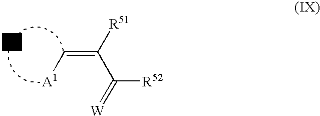

In Formula (IX), A¹ denotes a sulfur atom or NR⁵⁰, R⁵⁰ denotes an alkyl group or an aryl group, L² denotes a non-metallic atomic group forming a basic nucleus of a dye in cooperation with a neighboring A¹ and the neighboring carbon atom, R⁵¹ and R⁵² independently denote a hydrogen atom or a monovalent non-metallic atomic group, and R⁵¹ and R⁵² may be bonded together to form an acidic nucleus of a dye. W denotes an oxygen atom or a sulfur atom.

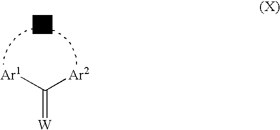

In Formula (X), Ar¹ and Ar² independently denote an aryl group and are connected to each other via a bond of —L³—. Here, L³ denotes —O—or —S—. W has the same meaning as that shown in Formula (IX).

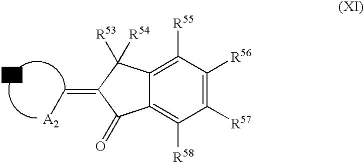

In Formula (XI), A₂ denotes a sulfur atom or NR⁵⁹, L⁴ denotes a non-metallic atomic group forming a basic nucleus of a dye in cooperation with the neighboring A₂ and carbon atom, R⁵³, R⁵⁴, R⁵⁵, R⁵⁶, R⁵⁷, and R⁵⁸ independently denote a monovalent non-metallic atomic group, and R⁵⁹ denotes an alkyl group or an aryl group.

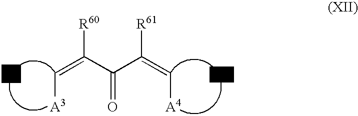

In Formula (XII), A³ and A⁴ independently denote —S—, —NR⁶²—, or —NR⁶³—, —R⁶² and R⁶³ independently denote a substituted or unsubstituted alkyl group, or a substituted or unsubstituted aryl group, L⁵ and L⁶ independently denote a non-metallic atomic group forming a basic nucleus of a dye in cooperation with the neighboring A³ and A⁴ and neighboring carbon atom, and R⁶⁰ and R⁶¹ independently denote a hydrogen atom or a monovalent non-metallic atomic group, or are bonded to each other to form an aliphatic or aromatic ring.

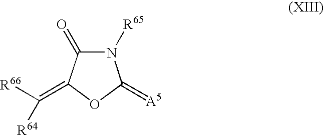

In Formula (XIII), R⁶⁶ denotes an aromatic ring or a hetero ring, which may have a substituent, and A⁵ denotes an oxygen atom, a sulfur atom, or —NR⁶⁷—. R⁶⁴, R⁶⁵, and R⁶⁷ independently denote a hydrogen atom or a monovalent non-metallic atomic group, and R⁶⁷ and R⁶⁴, and R⁶⁵ and R⁶⁷ may be bonded to each other to form an aliphatic or aromatic ring.

Specific examples of the compounds represented by Formulae (IX) to (XIII) include (E-1) to (E-20) listed below.

In some of the compound examples below, the hydrocarbon chain is described by a simplified structural formula in which symbols for carbon (C) and hydrogen (H) are omitted.

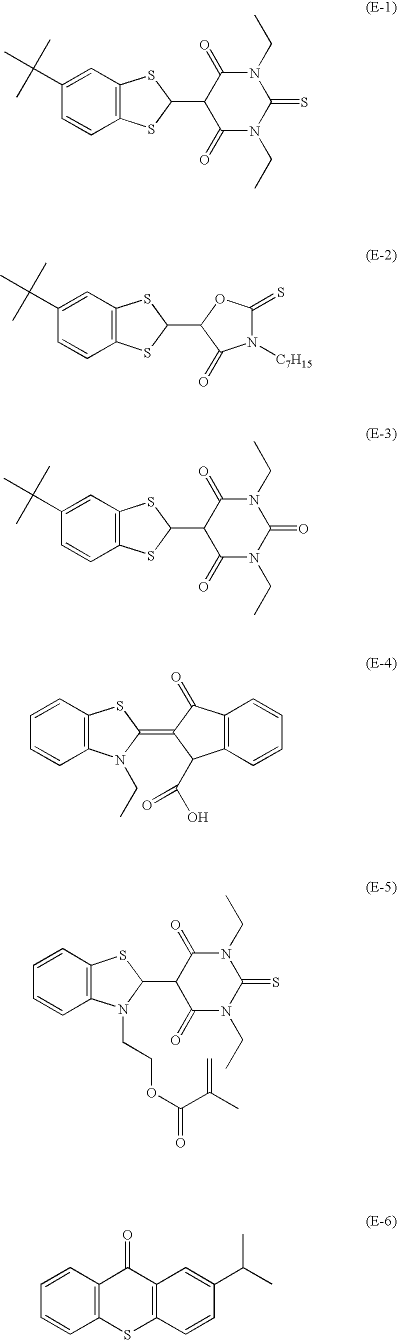

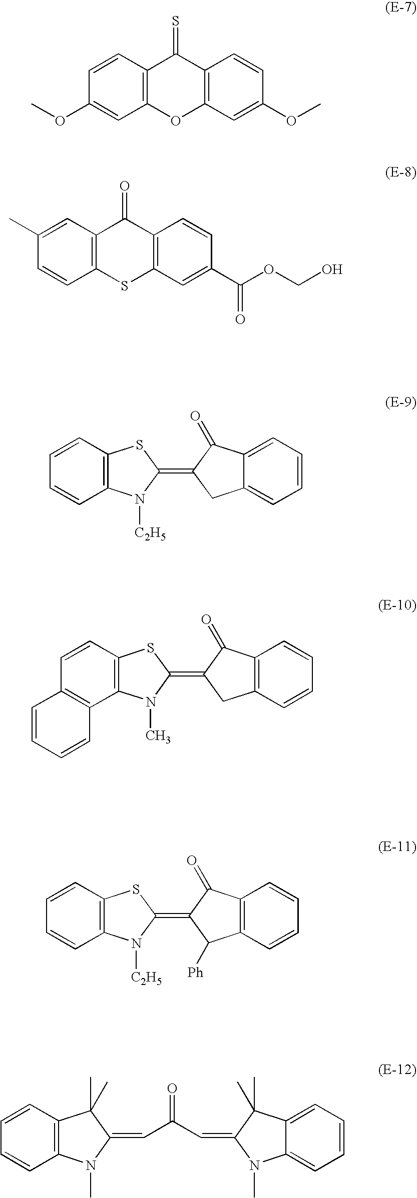

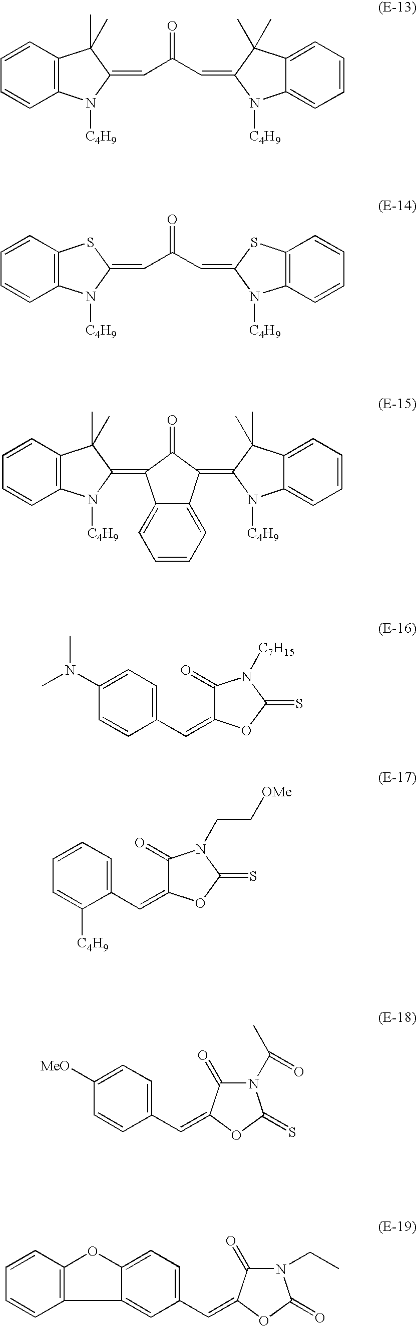

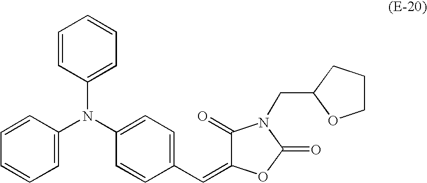

The content of the sensitizing colorant in the ink composition applicable in the present invention is appropriately selected according to the intended purpose, but it is generally preferably 0.05 to 4 wt % relative to the weight of the entire ink composition.

### Cosensitizer

The ink composition applicable in the present invention preferably comprises a cosensitizer. In the ink composition applicable in the present invention, the cosensitizer has the function of further improving the sensitivity of the sensitizing dye to actinic radiation or the function of suppressing inhibition by oxygen of polymerization of a polymerizable compound, etc.

Examples of such a cosensitizer include amines such as compounds described in M. R. Sander et al., “Journal of Polymer Society”, Vol. 10, p. 3173 (1972), JP-B-44-20189, JP-A-51-82102, JP-A-52-134692, JP-A-59-138205, JP-A-60-84305, JP-A-62-18537, JP-A-64-33104, and Research Disclosure No. 33825, and specific examples thereof include triethanolamine, ethyl p-dimethylaminobenzoate, p-formyldimethylaniline, and p-methylthiodimethylaniline.

Other examples of the cosensitizer include thiols and sulfides such as thiol compounds described in JP-A-53-702, JP-B-55-500806, and JP-A-5-142772, and disulfide compounds of JP-A-56-75643, and specific examples thereof include 2-mercaptobenzothiazole, 2-mercaptobenzoxazole, 2-mercaptobenzimidazole, 2-mercapto-4(3H)-quinazoline, and β-mercaptonaphthalene.

Yet other examples of the cosensitizer include amino acid compounds (e.g. N-phenylglycine, etc.), organometallic compounds described in JP-B-48-42965 (e.g. tributyltin acetate, etc.), hydrogen-donating compounds described in JP-B-55-34414, sulfur compounds described in JP-A-6-308727 (e.g. trithiane, etc.), and phosphorus compounds described in JP-A-6-250387 (diethylphosphite, etc.).

The content of the cosensitizer in the ink composition applicable in the present invention is appropriately selected according to the intended purpose, but it is generally preferably 0.05 to 4 wt % relative to the weight of the entire ink composition.

### Other Polymerizable Compound

The ink composition applicable in the present invention may comprise in combination as necessary a cationic polymerizable compound as another polymerizable compound. When a cationic polymerizable compound is used in combination, it is preferable to use a cationic polymerization initiator in combination as a polymerization initiator.

The cationic polymerizable compound applicable in the present invention is not particularly limited as long as it is a compound that undergoes a polymerization reaction by virtue of an acid generated by the photo-acid generator and is cured, and various types of cationic polymerizable monomers known as photo-cationic polymerizable monomers may be used. Examples of the cationic polymerizable monomer include epoxy compounds, vinyl ether compounds, oxetane compounds described in JP-A-6-9714, JP-A-2001-31892, JP-A-2001-40068, JP-A-2001-55507, JP-A-2001-310938, JP-A-2001-310937, JP-A-2001-220526, etc.

As the cationic polymerizable compound, for example, a cationic polymerizable type photocuring resin is known, and in recent years cationic photopolymerizable type photocuring resins sensitized to a visible light wavelength region of 400 nm or longer have been disclosed in, for example, JP-A-6-43633 and JP-A-8-324137. They may also be applied to the ink composition applicable in the present invention.

### Other Polymerization Initiator

The ink composition applicable in the present invention may comprise in combination as necessary a cationic polymerization initiator as another polymerization initiator When a cationic polymerization initiator is used in combination, it is preferable to use a cationic polymerizable compound in combination as a polymerizable compound.

Firstly, B(C₆F₅)₄⁻, PF₆⁻, AsF₆⁻, SbF₆⁻, and CF₃SO₃⁻ salts of diazonium, ammonium, iodonium, sulfonium, phosphonium, etc. aromatic onium compounds can be cited. Secondly, sulfonated materials that generate a sulfonic acid can be cited. Thirdly, halides that photogenerate a hydrogen halide can also be used. Fourthly, iron arene complexes can be cited.

Examples [(b-1) to (b-96)] of cationic polymerization initiators that are suitably applicable in the present invention are listed below, but the ink composition applicable in the present invention should not be construed as being limited thereby. In some of the compound examples below, the hydrocarbon chain is described by a simplified structural formula in which symbols for carbon (C) and hydrogen (H) are omitted.

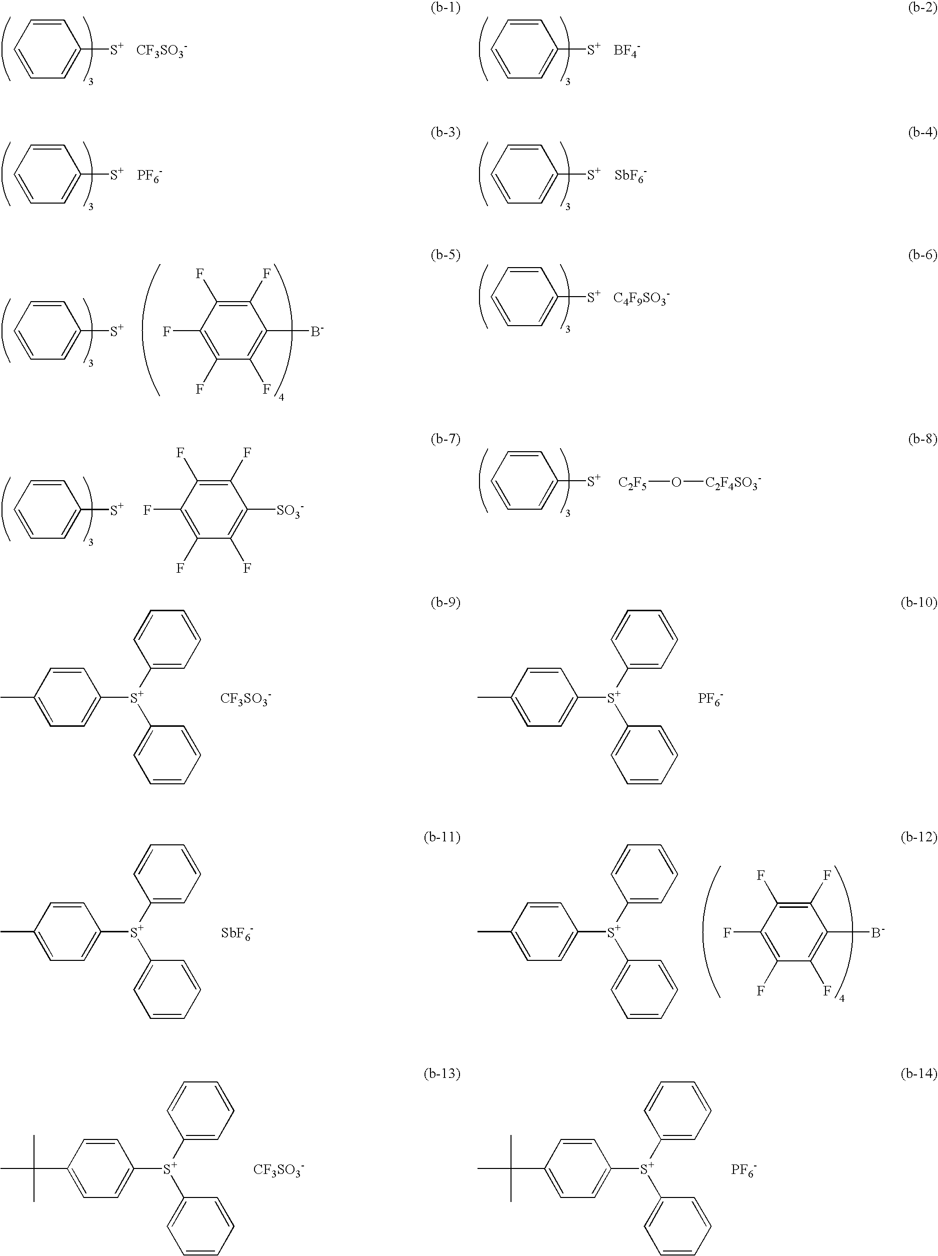

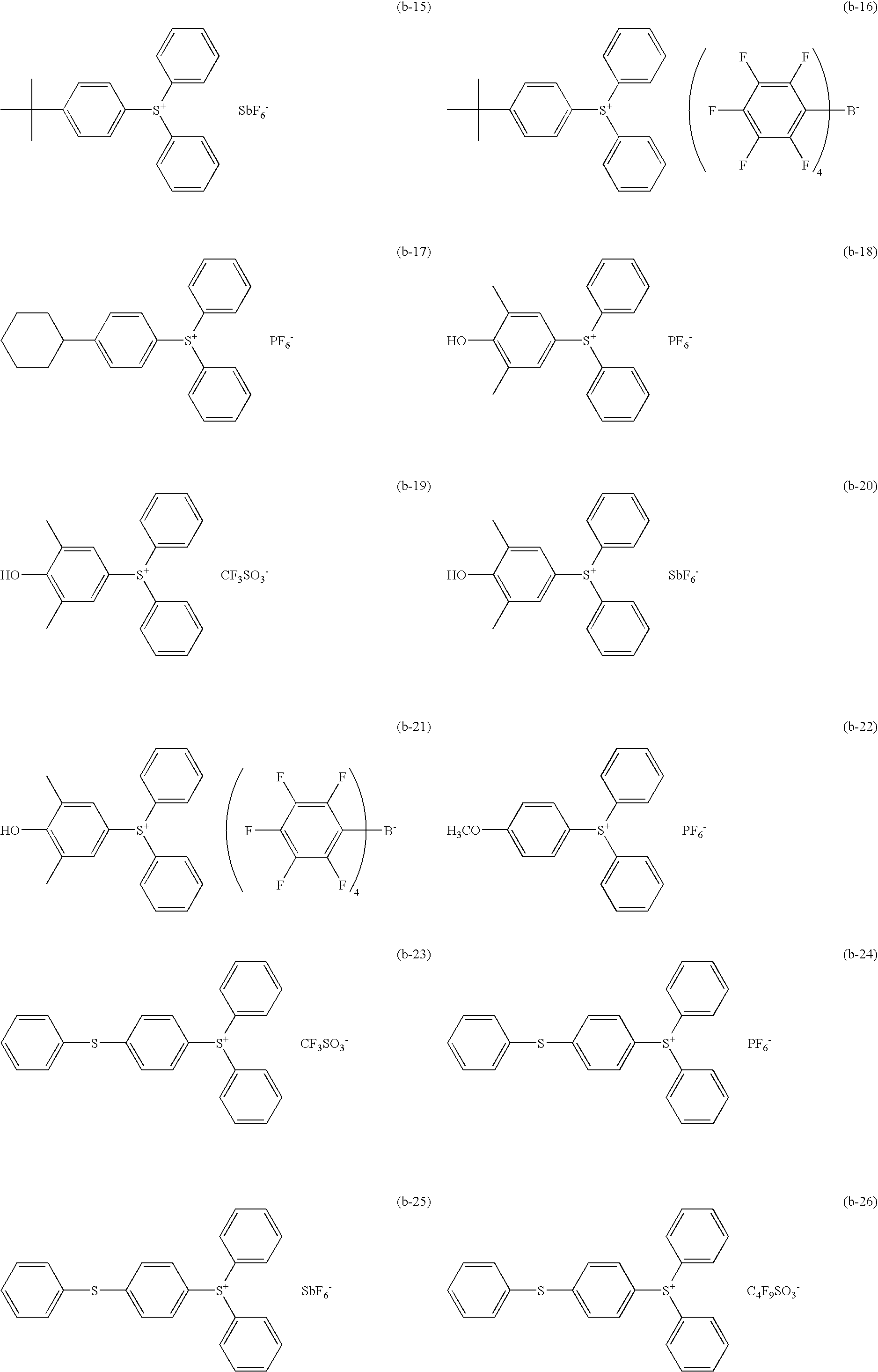

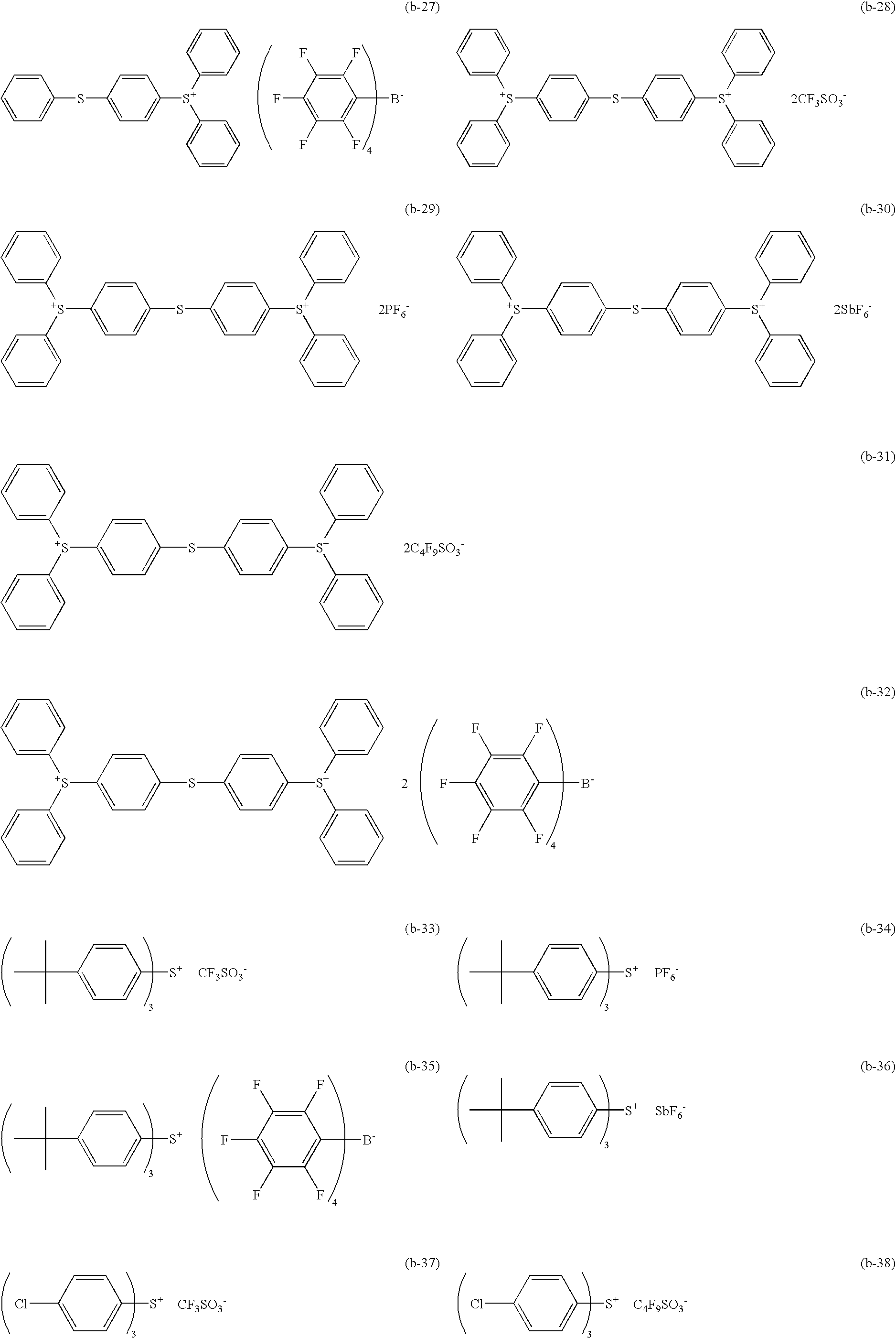

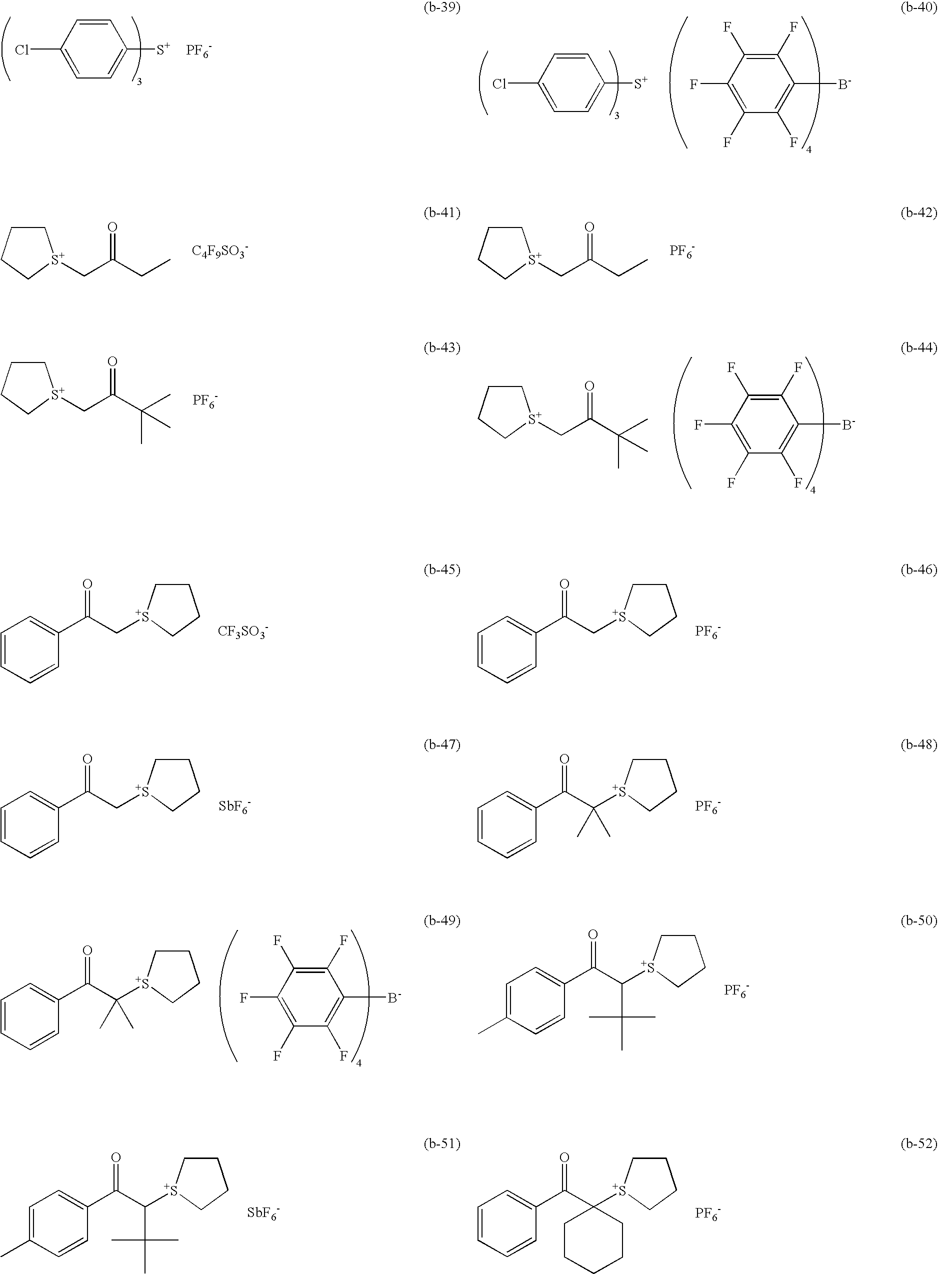

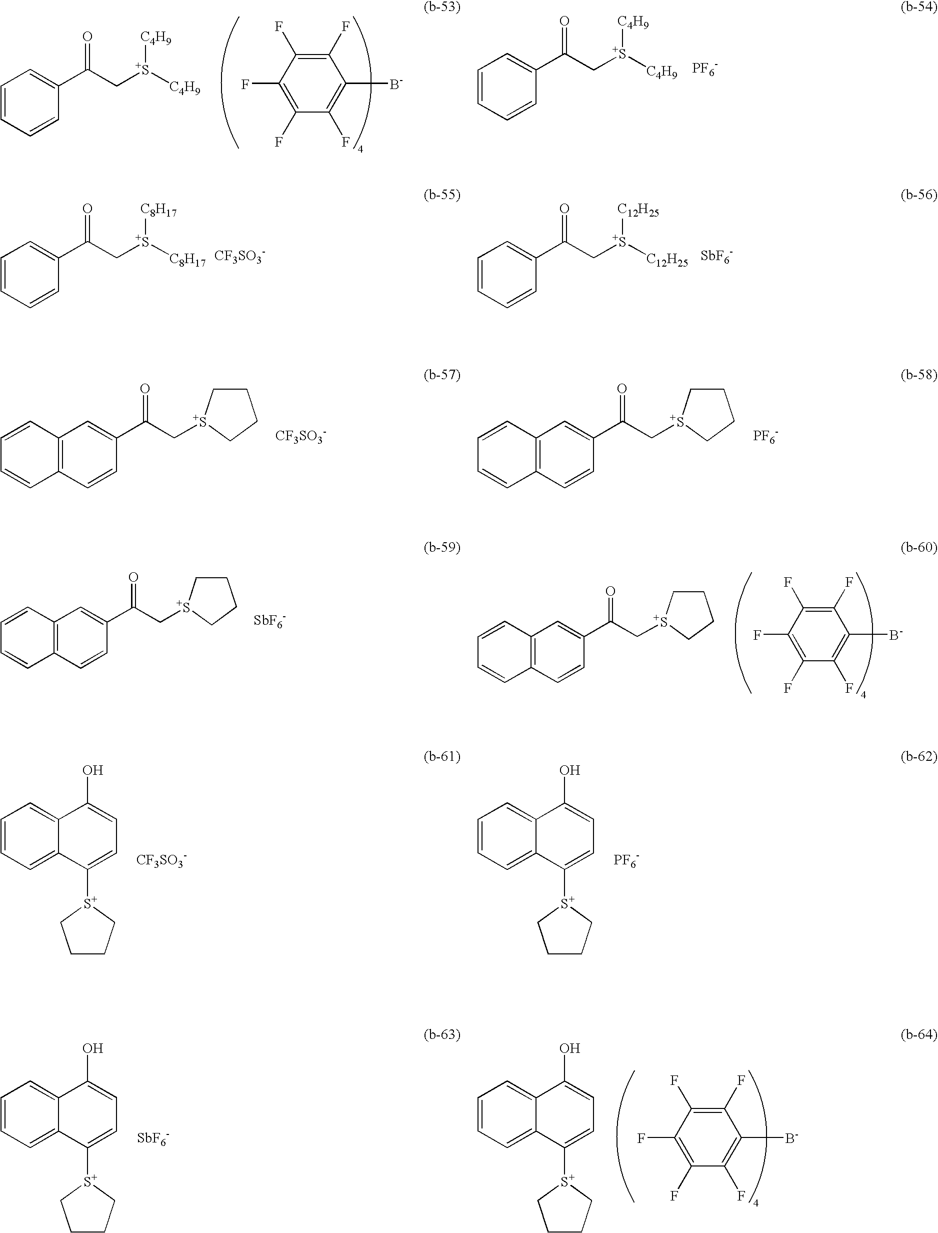

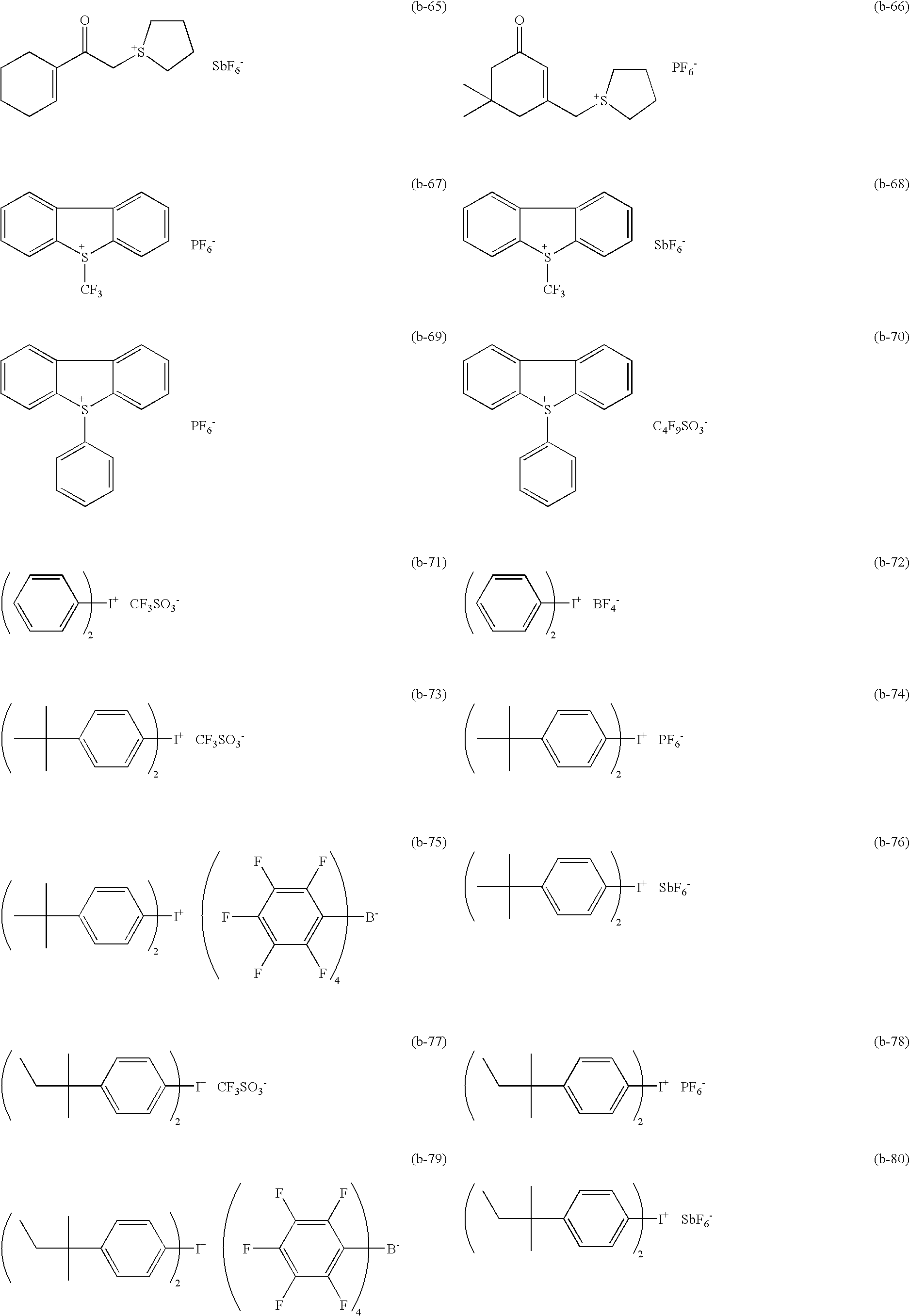

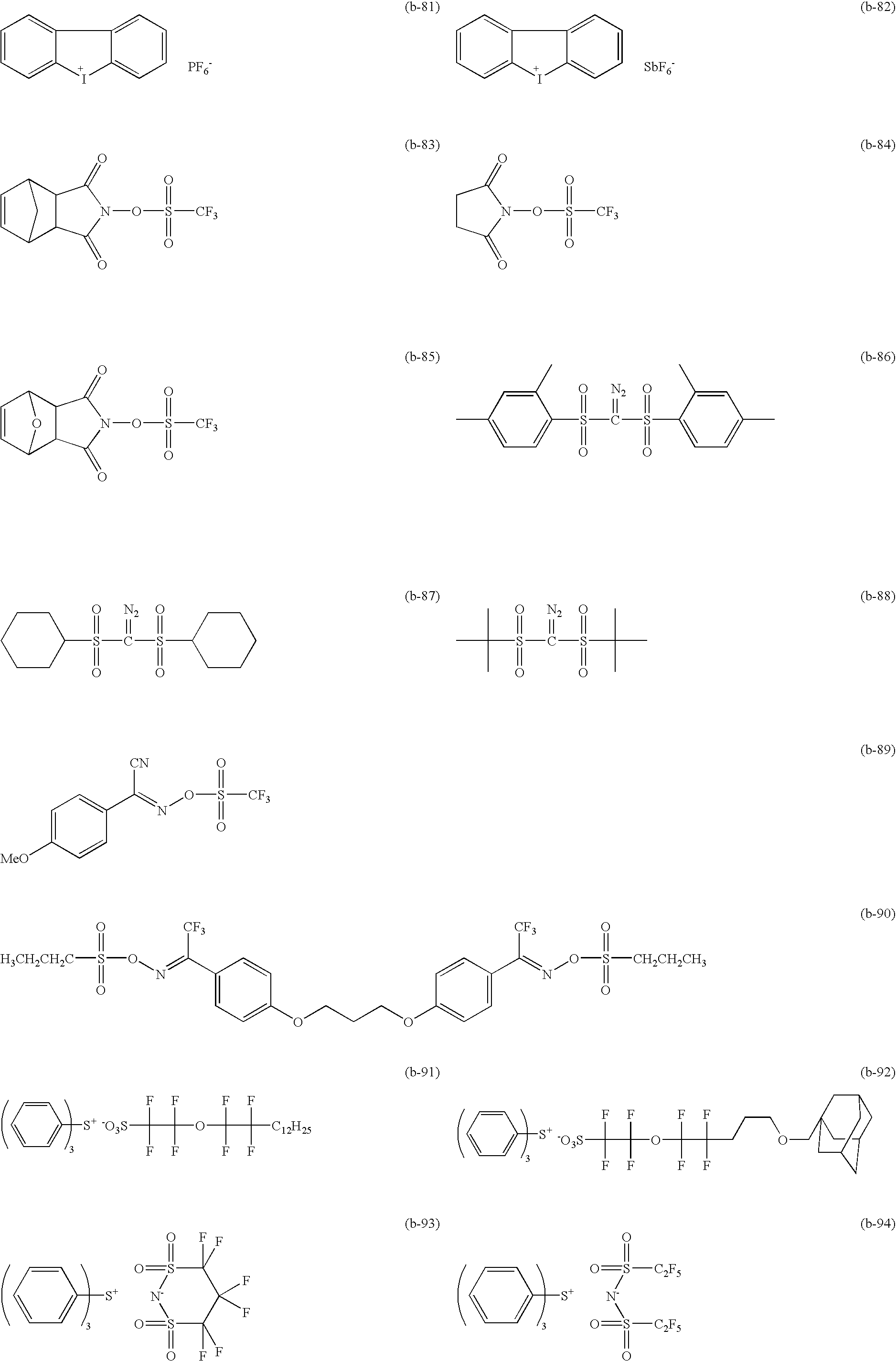

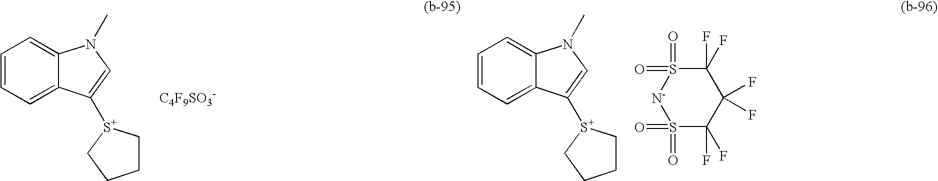

### UV Absorber

A UV absorber may be used in the ink composition applicable in the present invention from the viewpoint of improving the weather resistance of an image obtained and preventing discoloration.

The UV absorbers include benzotriazole compounds described in JP-A-58-185677, JP-A-61-190537, JP-A-2-782, JP-A-5-197075 and JP-A-9-34057; benzophenone compounds described in JP-A-46-2784, JP-A-5-194483 and U.S. Pat. No. 3,214,463; cinnamic acid compounds described in JP-B-48-30492, JP-B-56-21141 and JP-A-10-88106, triazine compounds described in JP-A-4-298503, JP-A-8-53427, JP-A-8-239368, P-A-10-182621 and JP-A-8-501291 (WO94/05645); compounds described in Research Disclosure No. 24239; and compounds represented by stilbene and benzoxazole compounds, which absorb ultraviolet rays to emit fluorescence, the so-called fluorescent brightening agents.

The amount thereof added is appropriately selected according to the intended application, and it is generally on the order of 0.5 to 15 wt % on the basis of the solids content in the ink composition.

### Antioxidant

In order to improve the stability of the ink composition, an antioxidant may be added. Examples of the antioxidant include those described in Laid-open European Patent Nos. 223739, 309401, 309402, 310551, 310552, and 459416, Laid-open German Patent No. 3435443, JP-A-54-48535, JP-A-62-262047, JP-A-63-113536, JP-A-63-163351, JP-A-2-262654, JP-A-2-71262, JP-A-3-121449, JP-A-5-61166, JP-A-5-119449, and U.S. Pat. Nos. 4,814,262 and 4,980,275.

The amount thereof added is appropriately selected according to the intended application, and it is preferably on the order of 0.1 to 8 wt % on the basis of the solids content in the ink composition.

### Antifading Agent

The ink composition applicable in the present invention may employ various organic and metal complex antifading agents. The organic antifading agents include hydroquinones, alkoxyphenols, dialkoxyphenols, phenols, anilines, amines, indanes, chromans, alkoxyanilines, and heterocycles, and the metal complex antifading agents include nickel complexes and zinc complexes. More specifically, there can be used compounds described in patents cited in Research Disclosure, No. 1764.3, Items VII-1 to J, ibid., No. 15162, ibid., No. 18716, page 650, left-hand column, ibid., No. 36544, page 527, ibid., No. 307105, page 872, and ibid., No. 15162, and compounds contained in general formulae and compound examples of typical compounds described in JP-A-62-21572, pages 127 to 137.

The amount thereof added is appropriately selected according to the intended application, and it is preferably on the order of 0.1 to 8 wt % on the basis of the solids content in the ink composition.

### Conductive Salt

The ink composition applicable in the present invention may contain, for the purpose of controlling discharge properties, a conductive salt such as potassium thiocyanate, lithium nitrate, ammonium thiocyanate, or dimethylamine hydrochloride.

### Solvent

It is also effective to add a trace amount of organic solvent to the ink composition applicable in the present invention in order to improve the adhesion to a recording medium.

The solvent in the ink composition applicable in the present invention, when using a resin as an inner construction of polymerization particles, has preferably 2 or greater solubility parameter (SP value) than that of the resin and more preferably 3 or greater.

Examples of the solvent include ketone-based solvents such as acetone, methyl ethyl ketone, and diethyl ketone, alcohol-based solvents such as methanol, ethanol, 2-propanol, 1-propanol, 1-butanol, and tert-butanol, chlorine-based solvents such as chloroform and methylene chloride, aromatic-based solvents such as benzene and toluene, ester-based solvents such as ethyl acetate, butyl acetate, and isopropyl acetate, ether-based solvents such as diethyl ether, tetrahydrofuran, and dioxane, and glycol ether-based solvents such as ethylene glycol monomethyl ether and ethylene glycol dimethyl ether.

In this case, it is effective if the amount thereof added is in a range that does not cause problems with the solvent resistance or the VOC, and the amount is preferably in the range of 0.1 to 5 wt % relative to the total amount of the ink composition, and more preferably 0.1 to 3 wt %.

### High Molecular Weight Compound

The ink composition applicable in the present invention may contain various types of high molecular weight compounds in order to adjust film physical properties. Examples of the high molecular weight compounds include acrylic polymers, polyvinylbutyral resins, polyurethane resins, polyamide resins, polyester resins, epoxy resins, phenol resins, polycarbonate resins, polyvinylbutyral resins, polyvinylformal resins, shellac, vinylic resins, acrylic resins, rubber-based resins, waxes, and other natural resins. They may be used in a combination of two or more types. Among these, a vinylic copolymer obtained by copolymerization of an acrylic monomer is preferable. Furthermore, as a copolymer component of the high molecular weight compound, a copolymer containing as a structural unit a “carboxyl group-containing monomer”, an “alkyl methacrylate ester”, or an “alkyl acrylate ester” may preferably be used.

### Basic Compound

It is preferable to add the basic compound from the viewpoint of improving the storage stability of the ink composition. As the basic compound in the ink composition applicable in the present invention, a known basic compound may be used and, for example, a basic inorganic compound such as an inorganic salt or a basic organic compound such as an amine is preferably used.

In addition to the above, the composition may contain as necessary, for example, a leveling additive, a matting agent, a wax for adjusting film physical properties, or a tackifier in order to improve the adhesion to a recording medium such as polyolefin or PET, the tackifier not inhibiting polymerization.

Specific examples of the tackifier include high molecular weight tacky polymers described on pp. 5 and 6 of JP-A-2001-49200 (e.g. a copolymer formed from an ester of (meth)acrylic acid and an alcohol having an alkyl group with 1 to 20 carbons, an ester of (meth)acrylic acid and an alicyclic alcohol having 3 to 14 carbons, or an ester of (meth)acrylic acid and an aromatic alcohol having 6 to 14 carbons), and a low molecular weight tackifying resin having a polymerizable unsaturated bond.

### <Properties of Ink Composition>

In the ink composition applicable in the present invention, the ink composition has a viscosity at 25° C. of no more than 40 mPa·s, preferably 5 to 40 mPa's, and more preferably 7to 30 mPa·s. Furthermore, the viscosity of the ink composition at the discharge temperature (preferably 25° C. to 80° C., and more preferably 25° C. to 50° C.) is preferably 3 to 15 mPa·s, and more preferably 3 to 13 mPa·s. With regard to the ink composition applicable in the present invention, it is preferable that its component ratio is appropriately adjusted so that the viscosity is in the above-mentioned range. When the viscosity at room temperature is set to be high, even when a porous recording medium is used, penetration of the ink composition into the recording medium can be prevented, and uncured monomer can be reduced. Furthermore, ink spreading when ink droplets have landed can be suppressed, and as a result there is the advantage that the image quality is improved.

The surface tension of the ink composition applicable in the present invention at 25° C. is preferably 20 to 35 mN/m, and yet more preferably 23 to 33 mN/m. When recording is carried out on various types of recording medium such as polyolefin, PET, coated paper, and uncoated paper, from the viewpoint of spread and penetration, it is preferably at least 20 mN/m, and from the viewpoint of wettability it is preferably not more than 35 mN/m.

### Description of Composition of the Head, Control of the Deposition, and Control of the Solidification Process

Next, an embodiment of the composition of the head 50 to carry out the image forming method described with reference to FIGS. 3A and 3B is explained. The head 50 shown in FIG. 5 includes a head block 50A, in which a plurality of nozzles 51 are arranged equidistantly along a sub-scanning direction perpendicular to a main scanning direction (represented with an arrow A) of the head 50, and an ultraviolet light irradiation block 50B having UV lamps of the same number with the nozzles 51 and arranged correspondingly to the nozzles 51. Thus, the head 50 has the structure in which each of the nozzles is provided with one of the UV light irradiation devices.

The head block 50A has the structure in which the nozzles 51 are arranged equidistantly in one row along the sub-scanning direction, and the ultraviolet light irradiation block 50B has the structure in which the UV lamps 16 of the same number as the nozzles 51 are arranged in the sub-scanning direction at the same arrangement pitch as the arrangement pitch of the nozzles 51. Furthermore, the ultraviolet light irradiation block 50B is disposed to the upstream side of the head block 50A in terms of the main scanning direction, and the phase of the nozzles 51 and the phase of the UV lamps 16 in the sub-scanning direction are mutually coinciding.

The diameter of the nozzles 51 in the head 50 shown in FIG. 5 is 25 μm, the nozzle pitch is 254 μm (100 npi), the distance between each nozzle 51 and the corresponding UV lamp 16 is 1 cm, the droplet ejection frequency is 1 kHz, and continuous droplet ejection can be carried out at a head conveyance speed of 0.1 m/s.

Next, the droplet deposition control and the ultraviolet light irradiation control of the head 50 shown in FIG. 5 will be described. The head 50 is controlled so as to eject the droplets from the nozzles 51 in accordance with the dot arrangement determined according to the prescribed droplet deposition data (image data).

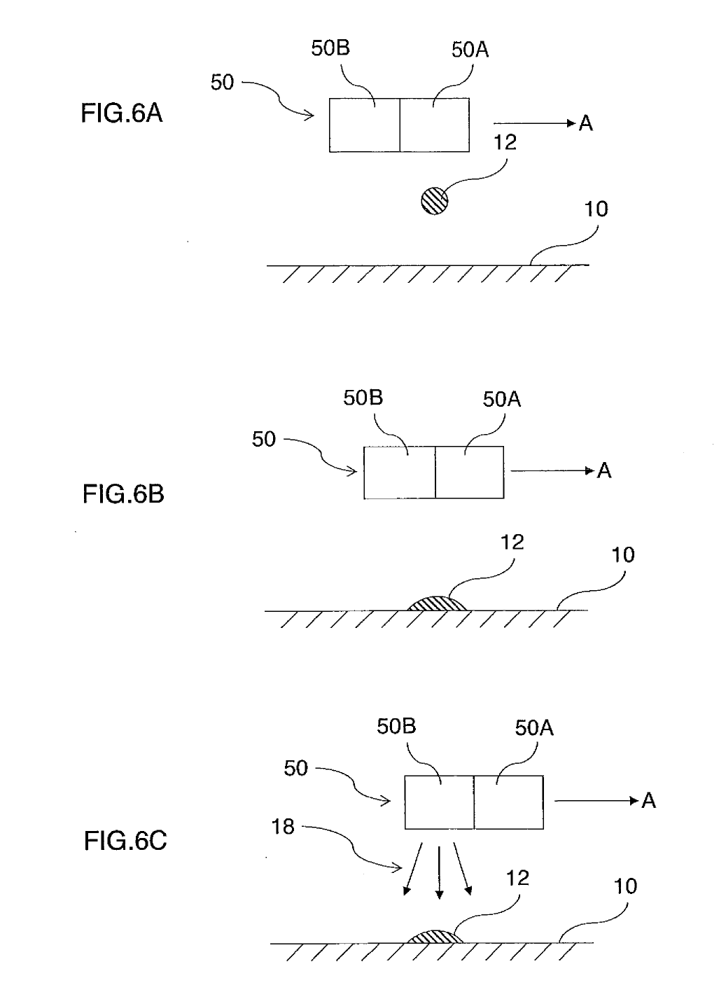

FIG. 6A shows a state where a droplet 12 has been ejected from the head block 50A toward the medium 10 (a state where the droplet is in flight through the space between the head 50 and the medium 10). Although FIG. 6A shows a state where the droplet 12 has been ejected from one of the nozzles 51 shown in FIG. 5, it is also possible for a plurality of droplets to be ejected at the same droplet ejection timing from the plurality of nozzles 51.

The head 50 ejects droplets successively while scanning the medium 10 in one direction of the main scanning direction shown by the arrow A, and thereby deposits the first droplets onto the range which can be printed in one scanning action in the direction A. FIG. 6B shows a state where the droplet 12 ejected at a certain ejection timing has landed on the medium 10.

As shown in FIG. 6C, when the ultraviolet irradiation block 50B arrives directly above the droplet 12 that has landed on the medium 10, the ultraviolet light 18 is irradiated from the ultraviolet irradiation block 50B. More specifically, the irradiation of ultraviolet light (the turning on and off of the UV lamp 16) is controlled as follows. The UV lamp 16 is turned on so that the ultraviolet light 18 is irradiated at the timing that the optical axis of the ultraviolet light 18 passes over the center of the droplet 12, and the UV lamp 16 is then turned off after a prescribed irradiation duration (=(the length of irradiation area of the ultraviolet light in the head traversing direction)/(the traversing speed of the head 50)) has elapsed from the turning-on timing of the UV lamp 16.

In other words, when a droplet 12 has been ejected from the head block 50A, the UV lamp 16 is turned on when a prescribed time (−(the arrangement distance between the nozzle 51 and the corresponding UV lamp 16)/(the traversing speed of the head 50)) has elapsed after the droplet ejection timing, thereby irradiating the ultraviolet light from the ultraviolet light irradiation block 50B, and the UV lamp 16 is turned off after the aforementioned irradiation duration has elapsed from the turning-on of the UV lamp 16.

Furthermore, it is preferable that the ultraviolet light irradiation block 50B is provided with an optical system that enhances the linearity of the ultraviolet light 18, and/or a shielding member that excludes the ultraviolet light from the UV lamps other than the particular UV lamp assigned to a certain nozzle so that the droplet having been ejected from the certain nozzle is not irradiated with the ultraviolet light 18 from the other UV lamps 16.

When a pattern created by the first droplets has been formed in this way in the region that can be printed (where the droplets can be deposited) by a single scanning action of the head 50, the head 50 is returned to the original position (the start positions of the first droplet deposition), and deposition of second liquid droplets is carried out. The droplet deposition process and solidification process are carried out for the second droplets in a similar fashion to the first droplets. Thus, the droplet deposition and solidification processes are repeated in one scanning area of the head 50 until the desired height (thickness) of the deposited layers is obtained.

When the three-dimensional pattern having the desired height has been formed on the region where the printing (the deposition of droplets) is possible in one scanning action of the head 50, the medium is moved in a sub-scanning direction which is perpendicular to the direction A, and another three-dimensional pattern is formed on the new printing region.

When the dots created by the droplets ejected from adjacent nozzles are formed at high density so as to be mutually overlapping, then a desirable mode is one in which thinning control is implemented in order that the droplets are not ejected simultaneously from mutually adjacent nozzles, but rather the droplets are ejected simultaneously from alternate nozzles and the region that can be printing by one scanning action is divided up accordingly into two scanning actions.

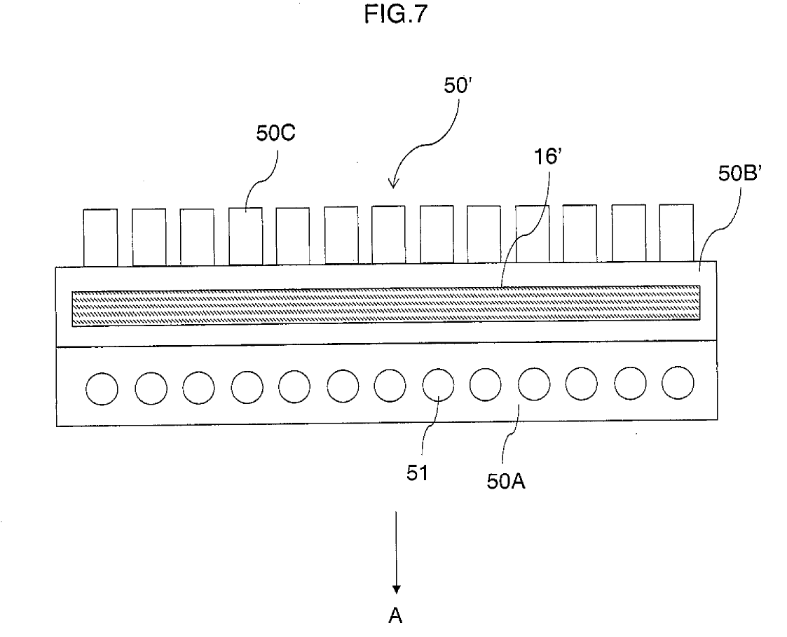

FIG. 7 shows another embodiment of the composition of the head 50 shown in FIG. 5. In the head 50′ shown in FIG. 7, a single UV lamp 16′ is used for the plurality of nozzles 51, shutter mechanisms 50C that control whether ultraviolet light is irradiated or not are arranged respectively for the nozzles 51, and the irradiation of ultraviolet light is controlled by means of these shutter mechanisms 50C.

More specifically, instead of the ultraviolet light irradiation block 50B of the head 50 shown in FIG. 5, the head 50′ shown in FIG. 7 has an ultraviolet light irradiation block 50B′ that includes the single UV lamp 16′ having a length corresponding to the length of the nozzle row in the sub-scanning direction (the length in the lateral direction in FIG. 7) and the shutter mechanisms 50C corresponding respectively to the nozzles 51. It is also possible to combine and use a plurality of UV lamps arranged in the sub-scanning direction so as to correspond to the length of the nozzle row in the sub-scanning direction.

As described above, one shutter mechanism 50C is provided for each nozzle, and the opening and closing of the shutter mechanisms 50C is controlled in accordance with the control of the deposition of liquid droplets.

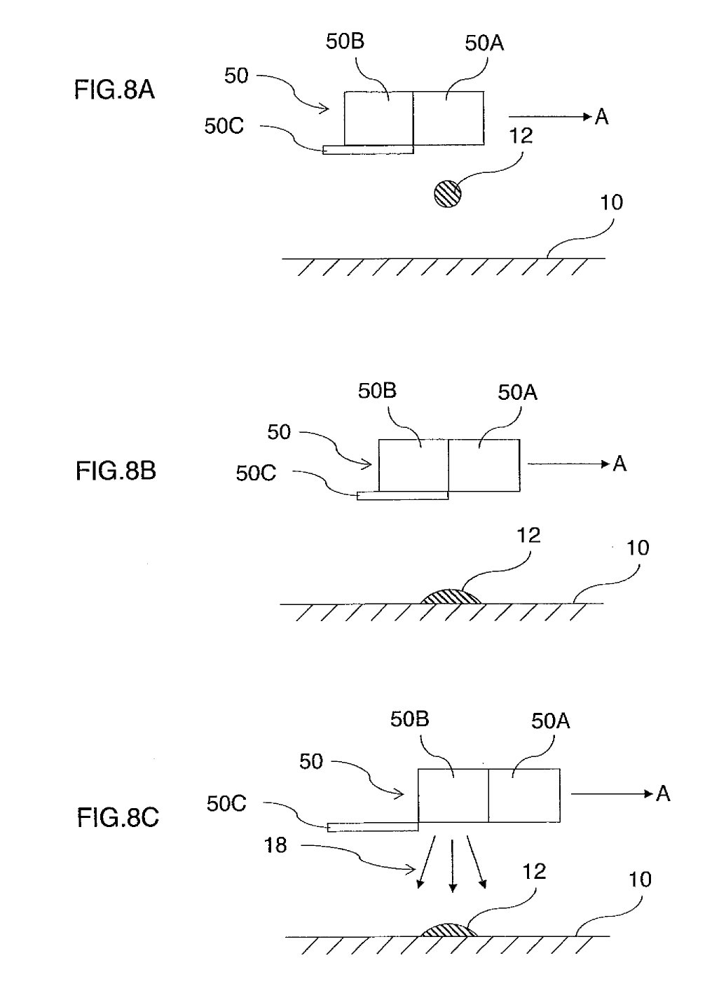

FIGS. 8A to 8C show schematic views of the droplet deposition control of the head 50′ and the opening and closing of the shutter mechanisms 50C shown in FIG. 7. FIG. 8A shows a state where a droplet 12 has been ejected from the head block 50A toward the medium 10. The shutter mechanism 50C is closed at the timing that the droplet 12 is ejected from the nozzle 51 and therefore even if the UV lamp 16′ is in the turned on state, the ultraviolet light is not irradiated onto the droplet 12.

The head 50 ejects droplets successively while scanning the medium 10 in one direction of the main scanning direction shown by the arrow A, and thereby deposits the first droplets onto the range which can be printed in one scanning action in the direction A. FIG. 8B shows a state where the droplet 12 ejected at a certain ejection timing has landed on the medium 10. The shutter mechanism 50C is also closed at the timing that the droplet 12 lands on the medium 10.

As shown in FIG. 8C, when the ultraviolet irradiation block 50B arrives directly above the droplet 12 that has landed on the medium 10, the ultraviolet light 18 is irradiated from the ultraviolet irradiation block 50B. More specifically, the opening and closing control of the shutter mechanism 50C is performed as follows. The shutter mechanism 50C is opened so that ultraviolet light 18 is irradiated at the timing that the optical axis of the ultraviolet light 18 passes over the center of the droplet 12, and the shutter mechanism 50C is then closed after a prescribed irradiation duration (=(the length of irradiation area of the ultraviolet light in the head traversing direction (A))/(the traversing speed of head 50)) has elapsed from the opening timing.

In other words, when a droplet 12 has been ejected from the head block 50A, the shutter mechanism 50C is opened when a prescribed time (=(the arrangement distance between the nozzle 51 and the UV lamp 16)/(the traversing speed of the head 50)) has elapsed after the droplet ejection timing, thereby irradiating the ultraviolet light from the ultraviolet light irradiation block 50B, and the shutter mechanism 50C is closed after the aforementioned irradiation duration has elapsed from the opening of the shutter mechanism 50C.

When a pattern created by the first droplets has been formed in this way in the region which can be printed (where the droplets can be deposited) by a single scanning action of the head 50, the head 50 is returned to the original position (the start position of the first droplet deposition), and deposition of second liquid droplets is carried out. In the case of the second droplets as well, the ejection of the droplets and the opening and closing of the shutter mechanisms 50C are controlled in a similar fashion to the first droplets. In this way, the droplet deposition and solidification processes are repeated in one scanning area of the head 50 until the desired height (thickness) of the deposited layers is obtained.

When the image forming method (droplet deposition control and solidification process) described in the present embodiment is adopted, then it is possible to stack together from five to seven droplets having an aspect ratio per droplet (ratio of thickness to diameter) of 0.1, and therefore it is possible to achieve an aspect ratio equal to or greater than 0.5 and less than 0.7 in the three-dimensional pattern.

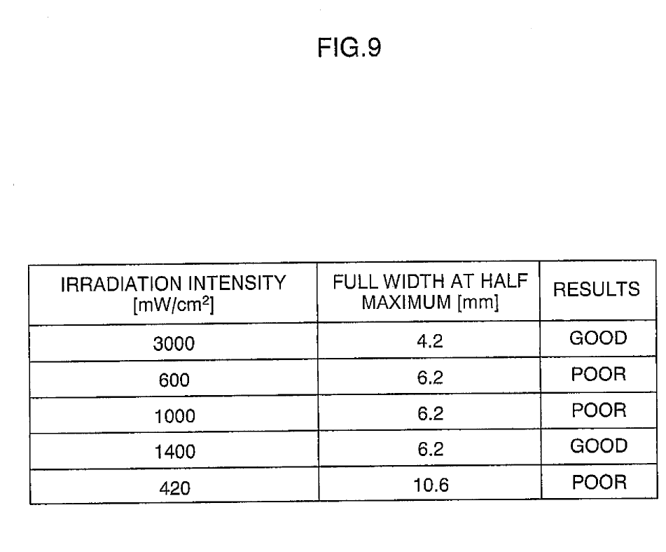

FIG. 9 shows examples of the parameter for control of the ultraviolet light irradiation. With droplets having the diameter of 3.0 mm in a stable state on the medium, the irradiation intensity (mW/cm²) and the full width at half maximum (mm) of the ultraviolet light beam were varied and it was confirmed visually whether or not the droplets solidified in the state where the upper surface of the droplets assume the depressed shape.

As shown in FIG. 9, it was confirmed that under the conditions of the ultraviolet light beam of the irradiation intensity 3000 mW/cm² and the full width at half maximum 4.2 mm, the droplet solidified while retaining the depressed shape in the central portion thereof. Furthermore, it was confirmed that under the conditions of the ultraviolet light beam of the irradiation intensity 1400 mW/cm² and the full width at half maximum 6.2 mm, the droplet solidified while retaining the depressed shape in the central portion thereof. On the other hand, the droplets could not be solidified while maintaining the recessed shape in the central portion thereof, under the conditions of the ultraviolet light beam where the irradiation intensity was 600 mW/cm² and the full width at half maximum was 6.2 mm, where the irradiation intensity was 1000 mW/cm² and the full width at half maximum was 6.2 mm, and where the irradiation intensity was 420 mW/cm² and the full width at half maximum was 10.6 mm.

If the aforementioned conditions are applied to a case where the diameter of the droplet is varied, then the full width at half maximum should be varied at the same ratio as the ratio of change of the diameter of the droplet. For example, if the diameter of the droplet is halved, then the full width at half maximum should also be halved.

The solidification time, which is the time period until the solvent component on the surface of the droplet evaporates off, under the above-described conditions is approximately 1.5 seconds, and the frequency of the droplet ejection is several Hz (several times per second). By reducing the full width at half maximum while increasing the irradiation intensity and thus raising the amount of light irradiated per unit surface area, it is possible to shorten the solidification time and to shorten the droplet ejection cycle.

### Modified Embodiments

The above-described embodiments relate to modes where the droplet is caused to solidify by the irradiation of ultraviolet light in a state where it maintains a shape where the recess portion 12A has been formed in the upper surface of the droplet, but as a method for creating a depressed shape of the upper surface of the droplet, it is also possible to:

(1) create a depressed shape of the droplet by catalyzing the solid only in the central portion of the droplet which has been deposited on the medium 10;

(2) create a depressed shape of the droplet by the light pressure of light that is directed onto only the central portion of the droplet; or

(3) create a depressed shape by applying an air flow.

Furthermore, as a method for solidifying the droplets, it is possible to:

(4) solidify the droplet by the irradiation of radiation by using a material that is solidified by the irradiation of the radiation other than ultraviolet light; or

(5) solidify the droplet by heating by using a material which is solidified by heat.

In other words, it is possible to solidify the droplet in a state where the upper surface of the droplet maintains the recessed shape, by suitably combining the methods (1) to (3) and the methods (4) to (5) described above.

According to the method of forming the three-dimensional pattern having the composition described above, since the layers of the liquid is stacked up by solidifying the droplets 12 in the state where the upper surface of the droplet 12 that has been deposited on the medium 10 has the depressed shape, it is possible to stack up the plurality of droplets without the liquid spreading in the breadthways direction when the layers of the liquid is stacked, and hence it is possible to form the desirable three-dimensional shape in which the width and the height are controlled independently.

### Embodiments of Apparatus

<General composition>

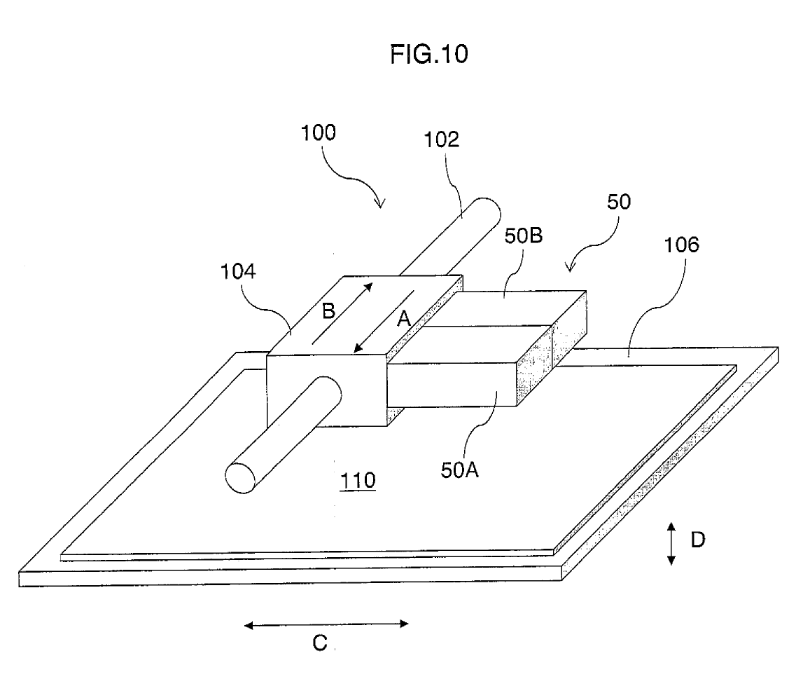

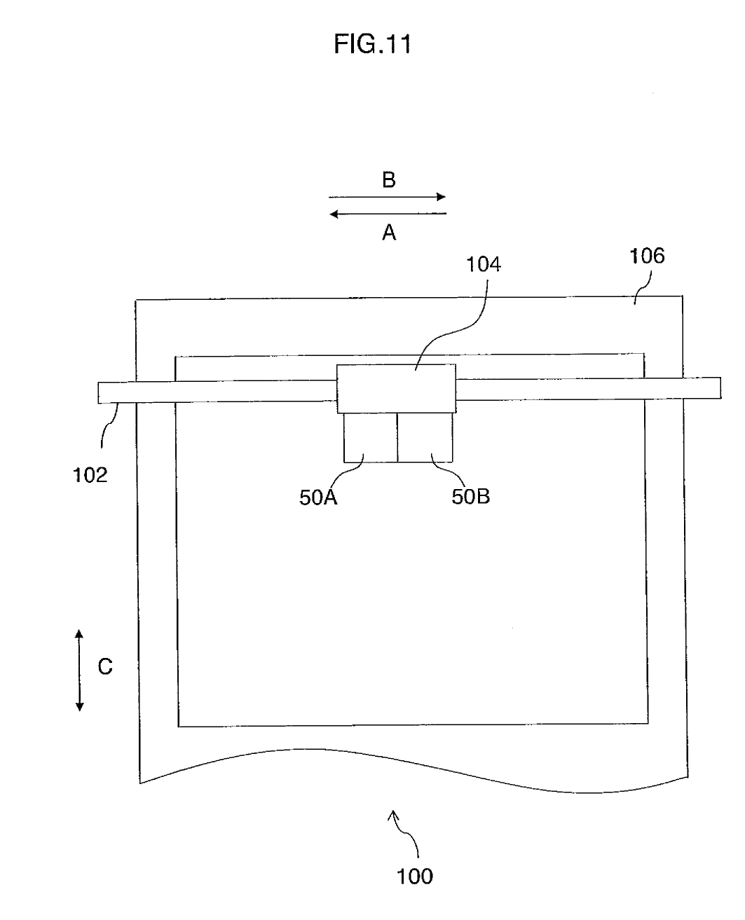

FIG. 10 shows the approximate composition of an image forming apparatus (inkjet recording apparatus) 100, which includes the head 50 shown in FIG. 5 (or the head 50′ shown in FIG. 7). Furthermore, FIG. 11 shows an approximate plan diagram of the image forming apparatus 100.

The image forming apparatus 100 shown in FIG. 10 includes a carriage 104, on which the head 50 equipped with the head block 50A and the ultraviolet light irradiation block 50B is mounted and which is composed so as to be movable in the main scanning direction (indicated by arrows A and B) by means of a scanning mechanism including a guide 102, and a substrate conveyance body 106, which supports a substrate 110 (a member corresponding to the medium 10 in FIGS. 1A to 1D) from the lower surface, namely, the surface on the opposite side to the surface where the droplets are deposited, and which is composed so as to be movable in the sub-scanning direction (indicated by arrows C and D). It is also possible to adopt a composition in which the substrate conveyance body 106 is composed so as to be rotatable about a rotating axis, which lies in parallel with the direction D, while maintaining a uniform distance between the head 50 and the surface that supports the substrate 110. Even if the substrate conveyance body 106 is composed so as to be rotatable, the movement directions in each of the C direction and the D direction are unchanged regardless of the rotation.

The direction A shown in FIG. 10 is the same direction as the scanning direction of the head 50 when forming a three-dimensional pattern on the substrate 110 (the direction shown in FIGS. 5 to 7), and the direction B is the direction of movement of the head when the head 50 is returned to its original position after printing has been completed for one scanning action of the head 50. In other words, the direction A and the direction B form a related outbound path and return path, and the irradiation of ultraviolet light is performed when the head 50 is moved in the direction A, while the ultraviolet light is not irradiated when the head 50 is moved in the direction B.

In the present embodiment, the substrate conveyance body 106 is moved in the direction D in accordance with the height of the three-dimensional pattern to be formed on the substrate 110, and the interval between the deposited droplet (three-dimensional pattern) and the head 50 is controlled so as to be uniform. More specifically, if the distance between the substrate conveyance body 106 and the head 50 is unchanged, then as the droplets are stacked upon each other, the distance between the head 50 and the deposited droplet (three-dimensional pattern) becomes smaller and there is a concern that ejection abnormalities may occur due to adherence of droplets to the ejection surface as a result of splash back after landing of the droplets and solidification of liquid inside the nozzles due to reflection of the ultraviolet light. Hence, the position in the direction D of the substrate conveyance body 106 is changed in such a manner that the distance between the surface of the droplet and the head 50 is within a prescribed range. It is also possible to change the position of the head 50 in the direction D.

FIG. 10 shows a mode where the head block 50A and the ultraviolet light irradiation block 50B are mounted on the common carriage 104 and both are moved in unison, however, it is also possible to mount the head block 50A and the ultraviolet light irradiation block 50B on separate carriages in such a manner that they are moved separately.

Furthermore, FIG. 10 shows a mode of a serial method in which the head 50 performs droplet ejection through a full range in the main scanning direction while traversing in the main scanning direction, and when droplet ejection has been completed once in the main scanning direction, the substrate 110 is moved in the sub-scanning direction and droplet ejection is performed in the main scanning direction onto the next region; however, it is also possible to adopt a droplet ejection method which uses a line type head in which nozzles are arranged through the full range of the substrate 110 in the main scanning direction.

<Structure of head>

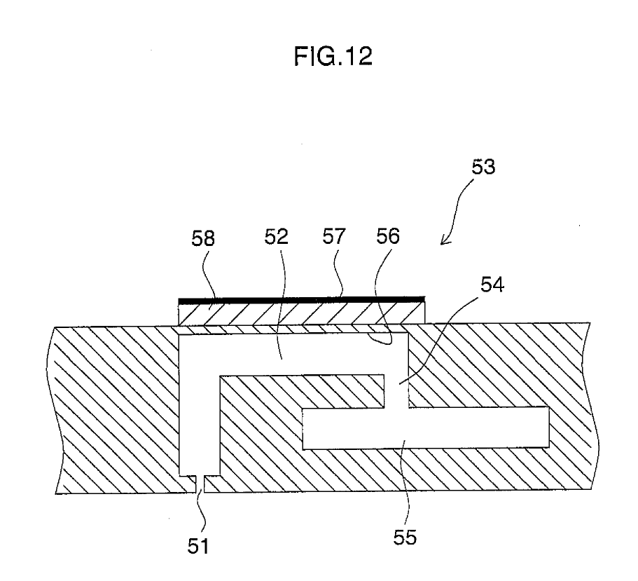

Next, the internal structure of the head 50 is described. FIG. 12 is an embodiment of the structure in which a piezoelectric element 58 is provided as an ejection force generating element, which acts on the liquid when ejecting a droplet of the liquid. The head 50 shown in FIGS. 5 and 7 has a structure in which ejection elements 53 each having the nozzles 51 and pressure chambers 52 are arranged in one row in the sub-scanning direction.

FIG. 12 shows an isolated view of one of the ejection elements 53 only. The pressure chamber 52, which is provided to correspond to the nozzle 51 as shown in FIG. 12, has a substantially square planar shape, in which an outlet port to the nozzle 51 is arranged in one corner on a diagonal of the pressure chamber and a supply port 54 to the pressure chamber 52 is arranged in the other corner on the diagonal. The shape of the pressure chamber 52 is not limited to that of the present embodiment, and various modes are possible in which the planar shape is a quadrilateral shape (rhombic shape, rectangular shape, or the like), a pentagonal shape, a hexagonal shape, or other polygonal shape, or a circular shape, elliptical shape, or the like.

The pressure chamber 52 is connected through the supply port 54 to a common flow channel 55. The common flow channel 55 is connected to a tank (not shown), which is a base tank that supplies liquid, and the liquid supplied from the tank is delivered through the common flow channel 55 to the pressure chambers 52.

The piezoelectric element 58 is provided with an individual electrode 57 and bonded to a pressure plate (a diaphragm that also serves as a common electrode) 56, which forms the surface of one portion (in FIG. 12, the ceiling) of the pressure chambers 52. When a drive signal is applied to the individual electrode 57 with respect to the common electrode, the piezoelectric element 58 deforms, thereby changing the volume of the pressure chamber 52. This causes a pressure change, which results in a droplet of the liquid being ejected from the nozzle 51. For the piezoelectric element 58, it is possible to adopt a piezoelectric element using a piezoelectric body, such as lead zirconate titanate, barium titanate, or the like. When the displacement of the piezoelectric element 58 returns to its original position after ejecting liquid, the pressure chamber 52 is replenished with new liquid from the common flow channel 55 via the supply port 54.

In the present embodiment, the method which pressurizes the liquid by means of the deformation of the piezoelectric element 58. In implementing the present invention, it is also possible to adopt an actuator based on another system other than a piezo element (for example, a thermal method), instead of the piezoelectric element 58.

FIGS. 13A and 13B show an embodiment of the structure of the head 50 (ejection element 53′) which employs the thermal method. As shown in FIG. 13A, in each pressure chamber 52′ which is branched off from a common flow channel 55, a heater 58′ is provided so as to correspond to each nozzle 51, and a droplet of the liquid is ejected from the nozzle 51 by means of a film boiling phenomenon which is produced when the liquid inside the pressure chamber 52′ is heated by means of the heater 58′. FIG. 13B is a cross-sectional diagram along line 13B-13B in FIG. 13A. As shown in FIG. 13B, the heater 58′ is provided on the surface of the pressure chamber 52 that opposes the nozzle 51.

Although not shown in the drawings, the image forming apparatus 100 includes a supply system for supplying the liquid to the head 50 and a maintenance unit which carries out maintenance of the head 50.

### Embodiment of Composition of Control System

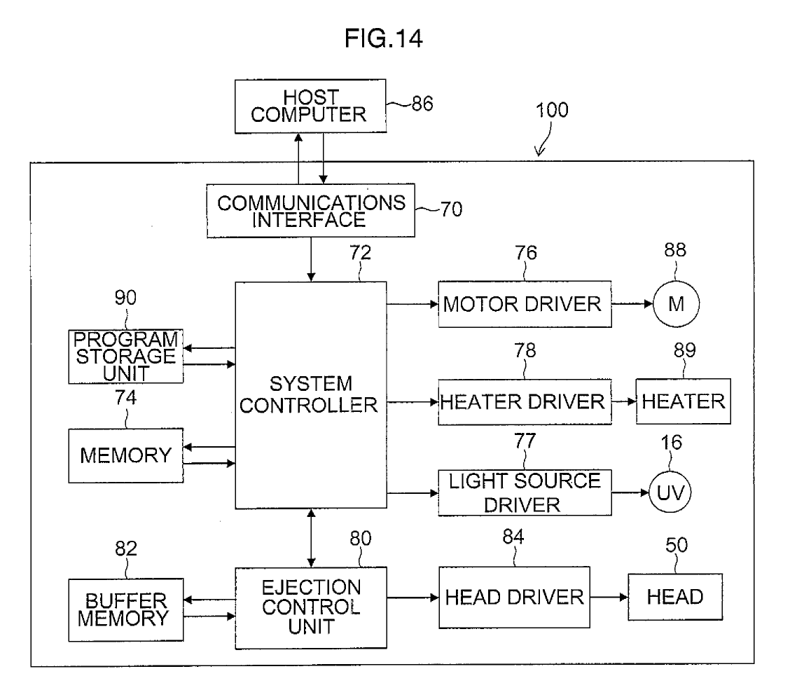

Next, the control system of the above-described image forming apparatus 100 is described. FIG. 14 is a principal block diagram showing the system configuration of the image forming apparatus 100. The image forming apparatus 100 includes a communication interface 70, a system controller 72, a memory 74, a motor driver 76, a light source driver 77, a heater driver 78, a droplet deposition controller 80, a buffer memory 82, a head driver 84, and the like.

The communication interface 70 is an interface unit for receiving droplet deposition data sent from a host computer 86. A serial interface such as USB (Universal serial Bus), IEEE1394, Ethernet, wireless network, or a parallel interface such as a Centronics interface may be used as the communication interface 70. A buffer memory may be mounted in this portion in order to increase the communication speed. The droplet deposition data sent from the host computer 86 is received by the image forming apparatus 100 through the communication interface 70, and is temporarily stored in the memory 74. The memory 74 is a storage device for temporarily storing dot pattern inputted through the communication interface 70, and data is written and read to and from the memory 74 through the system controller 72. The memory 74 is not limited to a memory composed of semiconductor elements, and a hard disk drive or another magnetic medium may be used.

The system controller 72 is a control unit which controls the respective sections, such as the communication interface 70, the memory 74, the motor driver 76, the heater driver 78, and the like. The system controller 72 is made up of a central processing unit (CPU) and peripheral circuits thereof, and as well as controlling communications with the host computer 86 and controlling reading from and writing to the memory 74, and the like, it generates control signals for controlling the motors 88 of the conveyance and drive system and the heaters 89.

The motor driver 76 is a driver (drive circuit) which drives the motor 88 of the conveyance and drive system in accordance with instructions from the system controller 72. The motor 88 of the conveyance drive system may be a motor which is a drive source of the carriage 104 in the drawings or a drive source of a movement mechanism of the substrate conveyance body 106.

The light source driver 77 controls the turning on and off and the quantity of irradiated light of the ultraviolet light source (UV lamp) 16 on the basis of a control signal which is supplied from the system controller 72.

The heater driver 78 is a driver which drives the heater 89 in accordance with instructions from the system controller 72. The heater 89 shown in FIG. 14 includes temperature adjustment heaters which are provided in the respective sections of the apparatus.

The droplet deposition controller 80 has a signal processing function for performing various tasks, compensations, and other types of processing for generating ejection control signals from the droplet deposition data stored in the memory 74 in accordance with commands from the system controller 72 so as to supply the generated ejection control signals (ejection data) to the head driver 84. Prescribed signal processing is carried out in the droplet deposition controller 80, and the ejection amount and the ejection timing of the liquid from the print head 50 are controlled via the head driver 84, on the basis of the droplet deposition data.

The droplet deposition controller 80 is provided with the buffer memory 82; and droplet deposition data, parameters, and other data are temporarily stored in the buffer memory 82 when droplet deposition data is processed in the droplet deposition controller 80. The aspect shown in FIG. 14 is one in which the image buffer memory 82 accompanies the droplet deposition controller 80; however, the memory 74 may also serve as the image buffer memory 82. Also possible is an aspect in which the droplet deposition controller 80 and the system controller 72 are integrated to form a single processor.

The head driver 84 drives the piezoelectric element 58 (heater 58′) of the head 50 on the basis of ejection data supplied by the droplet deposition controller 80. The head driver 84 can be provided with a feedback control system for maintaining constant drive conditions for the print heads.

Control programs for the image forming apparatus 100 are stored in the program storage unit 90, and the system controller 72 reads out various control programs which are stored in the program storage unit 90 as and when appropriate, and executes the control programs.

One example of the application of the image forming apparatus described above is for the formation of a block matrix pattern having a wire width of 8 μm to 10 μm.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. An image forming method for forming a three-dimensional shape on a medium by stacking up a plurality of droplets of liquid on a same droplet deposition point on the medium, the method comprising the steps of:
depositing a first droplet of the liquid onto the medium;
then solidifying the first droplet while carrying out a process whereby an upper surface of the first droplet assumes a depressed shape; and
then depositing a second droplet of the liquid onto the first droplet.

2. The image forming method as defined in claim 1, wherein:
the liquid has a function of being solidified when being irradiated with radiation; and
the solidifying step includes the step of irradiating the radiation more intensely onto a prescribed region including a central portion of the first droplet than another region of the first droplet.

3. The image forming method as defined in claim 1, wherein:
the liquid has a function of being solidified when being irradiated with radiation; and
the solidifying step includes the steps of:
inserting a hollow needle having a diameter smaller than a diameter of the first droplet into the upper surface of the first droplet;
then irradiating the radiation from periphery of the first droplet in a state where the hollow needle is being inserted in the upper surface of the first droplet; and
then suctioning the liquid inside the hollow needle that is left without being solidified.

4. An image forming apparatus, comprising:
a head provided with a nozzle which performs ejection of a droplet of liquid toward a medium;
a solidification device which solidifies the droplet that has been deposited on the medium while carrying out a process whereby an upper surface of the droplet assumes a depressed shape; and
a droplet ejection control device which controls the ejection of a subsequent droplet of the liquid onto the droplet that has the upper surface formed in the depressed shape and has been solidified by the solidification device, whereby forming a three-dimensional shape on the medium by stacking up the droplets.

5. The image forming apparatus as defined in claim 4, wherein:
the liquid has a function of being solidified when being irradiated with radiation; and
the solidification device includes:
a radiation irradiation device which irradiates the radiation onto the droplet; and
a radiation irradiation control device which controls the radiation irradiation device in such a manner that the radiation is irradiated intensely onto a prescribed region including a central portion of the droplet than another region of the droplet.

6. The image forming apparatus as defined in claim 5, further comprising:
a head movement device which moves the head relative to the medium; and
a radiation source movement device which moves the radiation irradiation device relative to the medium, wherein:
the radiation irradiation device is arranged to an upstream side of the head in terms of a direction of movement of the movement device, and moves while following the head; and
the radiation irradiation control device controls turning on and off of the radiation irradiation device in such a manner that the radiation is irradiated onto the droplet that is being situated directly below the radiation irradiation device.

7. The image forming apparatus as defined in claim 5, further comprising:
a head movement device which moves the head relative to the medium;
a radiation source movement device which moves the radiation irradiation device relative to the medium; and
a shutter mechanism which is arranged between the radiation irradiation device and the medium,
wherein the radiation irradiation control device controls turning on and off of the radiation irradiation device by opening and closing the shutter mechanism in such a manner that the radiation is irradiated onto the droplet that is being situated directly below the radiation irradiation device.

8. The image forming apparatus as defined in claim 4, wherein:
the liquid has a function of being solidified when being irradiated with radiation; and
the solidification device includes:
a hollow needle which has a diameter smaller than a diameter of the droplet;
a needle movement device which inserts the hollow needle into the upper surface of the droplet;
a liquid removal device which removes the liquid inside the hollow needle;
a radiation irradiation device which irradiates the radiation onto the droplet;
a radiation irradiation control device which controls the radiation irradiation device and the needle movement device so as to perform irradiation of the radiation from periphery of the droplet in a state where the hollow needle is being inserted in the upper surface of the droplet; and
a liquid removal control device which controls the liquid removal device so as to remove the liquid inside the hollow needle that is left without being solidified after the irradiation of the radiation.
